(19) United States
(12) Patent Application Publication
(10) Pub. No.: US 2009/0079689 A1
(43) Pub. Date: Mar. 26, 2009

(54) Display Device And Electric Apparatus Using The Same

(76) Inventors: Akio Miyata, Nara (JP); Shinichi Nakano, Nara (JP); Shuichi Kozaki, Nara (JP); Hiroko Niwano, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/988,106

(22) PCT Filed: Jul. 14, 2006
(86) PCT No.: PCT/JP2006/314094

§ 371 Date: Dec. 31, 2007

(30) Foreign Application Priority Data
Jul. 14, 2005 (JP) 2005-206143

(51) Int. Cl. G09G 3/34

(52) U.S. Cl. 345/107

(57) ABSTRACT

A standard electrode 19, and a plurality of signal electrodes 15 and a plurality of scanning electrodes 22 that cross each other are provided. A scanning driver Vd, which applies either one of a non-selected voltage that inhibits movement of a conductive liquid inside a liquid storage space and a selected voltage that allows the conductive liquid to move inside the liquid storage space according to a signal voltage to the signal electrode 15 to each of the scanning electrodes 22, when a standard driver Vs applies a standard voltage to the standard electrode 19, is provided.

### TECHNICAL FIELD

The present invention relates to a display device that displays information such as images and letters by moving a conductive liquid, and an electric apparatus using the same.

### BACKGROUND ART

Conventionally, display devices that display information by utilizing a moving phenomenon of a transparent or colored liquid have been suggested. For example, display devices that utilize an external electric field to move a liquid, thereby displaying information, include those of an electroosmosis system and of an electrowetting system.

In the display devices of the electroosmosis system, a liquid impregnation rate of a surface of a porous body is controlled so as to scatter external light, whereby a light reflectance and a light transmittance thereof with respect to the external light are controlled. Also, these display devices of the electroosmosis system have a configuration in which the porous body and the transparent liquid that have an equal refractive index are prepared in advance so as to achieve transparency by filling the liquid in through holes (small holes) in the porous body and cause light to be scattered by allowing the liquid to flow out from the through holes.

In the display devices of the electrowetting system, an electric field is applied to a liquid inside small pores so as to vary an interfacial tension of the liquid, thus causing this liquid to move by an electrocapillary phenomenon (an electrowetting phenomenon). More specifically, when a switch between a pair of electrodes provided on an inner surface of a small hole is dosed so as to apply the electric field to the liquid, a wettability of the liquid with respect to the inner surface of the small hole varies. Accordingly, a contact angle of the liquid with respect to the inner surface of the small hole decreases, so that the liquid moves inside the small hole. On the other hand, when the switch is opened to stop the application of the electric field to the liquid, the wettability of the liquid with respect to the inner surface of the small hole varies, thus increasing the contact angle sharply, so that the liquid flows out from the small hole.

In order to display moving images in the display devices described above, the liquid has to be moved inside the small hole at a high speed and at a low voltage. When the electroosmosis system and the electrowetting system are compared in this respect, the electrowetting system is more suitable for displaying moving images because it can move the liquid at a higher speed.

Further, using the conventional display devices, image displays utilizing the electrowetting phenomenon are provided as described in JP 10 (1998)-39799 A, for example.

More specifically, as shown in FIG. 20, a display device according to the above-noted conventional example is constituted by transparent sheets, and includes a first sheet 1, a second sheet 2 and a third sheet 3 that are arranged in this order from an upper side of FIG. 20 (a display surface side) with predetermined gaps therebetween. An upper side passage 4 is provided between the first sheet 1 and the second sheet 2, and a lower side passage 5 is provided between the second sheet 2 and the third sheet 3. Also, the second sheet 2 is provided with reservoirs 6 and 7 that allow the upper side passage 4 and the lower side passage 5 to communicate with each other. Furthermore, inside the upper side passage 4, the lower side passage 5, the reservoirs 6 and 7, a conductive liquid L1 that is colored in a predetermined color and a transparent liquid L2 that is transparent are sealed.

Moreover, in this display device according to this conventional example example, first electrodes 8A and 8B respectively are disposed on a lower surface side of the first sheet 1 and an upper surface side of the second sheet 2 so as to sandwich the upper side passage 4. Also, inside the upper side passage 4, a second electrode 9 is disposed at a position opposed to an upper end opening of the reservoir 6. The first electrodes 8A, 8B and the second electrode 9 are connected with a direct current power supply as shown in FIG. 10, thereby making it possible to apply an electric field to the conductive liquid L1.

In the display device according to the conventional example example having the above-described configuration, a circuit between the first electrodes 8A, 8B and the second electrode 9 is closed to apply a voltage between these electrodes, thereby both moving the transparent liquid L2 inside the upper side passage 4 to a side of the lower side passage 5 and moving the conductive liquid L1 from a side of the reservoir 6 to a side of the upper side passage 4, and so as to cause the above-mentioned predetermined color to be present on the display surface side.

On the other hand, the above-described circuit is opened, thereby both returning the conductive liquid L1 from the side of the upper side passage 4 to the side of the reservoir 6 and moving the transparent liquid L2 from the side of the reservoir 7 to the side of the upper side passage 4, so that the transparent display is achieved on the display surface side.

### DISCLOSURE OF INVENTION

### Problem to be Solved by the Invention

By the way, in the conventional display device as described above, for example, a simple matrix system (passive matrix system) and an active matrix system can be adopted as a driving system thereof.

The display device of the simple matrix system, which is known well as a liquid crystal display and the like, is provided with two layers of electrodes arranged in matrix, which are an X electrode that is patterned in stripe in an X direction and a Y electrode that is patterned in stripe in a Y direction. And, in the simple matrix system, by applying voltage pulses to the X electrode and the Y electrode at appropriate timings, a pixel in each of cross portions of the X electrodes and the Y electrodes is allowed to perform a display operation without using any active element such as a TFT (Thin Film Transistor) or the like, whereby it is possible to manufacture a display device with a simple structure at low cost.

However, as is known, in the display device of the simple matrix system as described above, by applying a voltage to each of the X electrodes sequentially, a line of the X electrode is selected one by one and an input voltage corresponding to the selected line is applied to the Y electrode so as to perform scanning display. Thus, in the display device of the simple matrix system, a slight voltage is applied also to a non-selected line that is adjacent to the selected line by the influence of a leakage current and the like so as to cause a semi-selecting state, which may result in a problem of a crosstalk.

On the other hand, in the display device of the active matrix system, by providing a switching element such as the TFT and a diode element to each pixel, it is possible to control a voltage that is applied to each pixel, thereby solving the problem of the crosstalk. However, in the display device of this active matrix system, since the active element as described above is provided to each pixel, a process for manufacturing the display element is complicated, and the number of members to be provided is increased, thereby causing a new problem of increasing the manufacturing cost of the display device.

In the light of the above-described problems, it is an object of the present invention is to provide a display device that can prevent the generation of the crosstalk without the provision of the active element, and an electric apparatus using the same.

### Means for Solving Problem

In order to attain the above-described object, the display device of the present invention is a display device provided with:

a transparent upper layer that is provided on a display surface side;

an intermediate layer that is provided on a back surface side of the upper layer such that a predetermined upper space is formed between the upper layer and the intermediate layer;

a lower layer that is provided on a back surface side of the intermediate layer such that a predetermined lower space is formed between the lower layer and the intermediate layer;

a communication space that is provided in the intermediate layer such that the upper space and the lower space are connected; and

a conductive liquid sealed movably inside a liquid storage space that is constituted of the upper space, the lower space and the communication space,

wherein a display color on the display surface side can be changed by moving the conductive liquid,

the display device including:
a standard electrode that is provided on the upper layer or the lower layer;
a plurality of signal electrodes that are provided on the intermediate layer;
a plurality of scanning electrodes that are provided on the upper layer or the lower layer so as to cross the plurality of the signal electrodes;
a standard voltage applying portion that is connected with the standard electrode and applies a predetermined standard voltage to the standard electrode;
a signal voltage applying portion that is connected with the plurality of the signal electrodes and applies, to each of the plurality of the signal electrodes, a signal voltage according to information to be displayed on the display surface; and
a scanning voltage applying portion that is connected with the plurality of the scanning electrodes, and applies, to each of the plurality of the scanning electrodes, one of a non-selected voltage that inhibits movement of the conductive liquid inside the liquid storage space and a selected voltage that allows the conductive liquid to move inside the liquid storage space according to the signal voltage, when the standard voltage applying portion applies the standard voltage to the standard electrode.

In the display device structured as described above, the plurality of the signal electrodes and the plurality of the scanning electrodes are provided so as to cross each other, and are arranged in matrix. Moreover, the scanning voltage applying portion, which applies, to each of the plurality of the scanning electrodes, one of the non-selected voltage that inhibits the movement of the conductive liquid inside the liquid storage space and the selected voltage that allows the conductive liquid to move inside the liquid storage space according to the signal voltage, when the standard voltage applying portion applies the standard voltage to the standard electrode, is provided. Thereby, the generation of a crosstalk can be prevented without providing an active element.

Moreover, in the display device, a plurality of pixel regions are set on the display surface, each of the plurality of the pixel regions is provided in each cross portion of the signal electrode and the scanning electrode, and the liquid storage space is partitioned by a partition wall in each of the plurality of the pixel regions.

In this case, in each of the plurality of the pixels on the display surface, the display color on the display surface side can be changed by each pixel by moving the conductive liquid without generating the crosstalk.

Moreover, in the display device, the plurality of the pixel regions are respectively provided on the display surface side according to a plurality of primary colors that enable full-color display.

In this case, the conductive liquid corresponding to each of the plurality of the pixels is moved appropriately, so that the color image display can be achieved.

Moreover, in the display device, the standard voltage applying portion switches a polarity of the standard voltage at every predetermined period of time, and the scanning voltage applying portion switches respective polarities of the non-selected voltage and the selected voltage so as to correspond to the switching of the polarity of the standard voltage.

In this case, localization of charges of the standard electrode and the scanning electrode can be prevented more, compared with the case of applying a voltage with the same polarity continuously to the standard electrode and the scanning electrode.

Moreover, in the display device, the signal voltage applying portion changes the signal voltage based on an image input signal from an outside. In this case, gradation display is performed on the display surface according to the image input signal.

Moreover, in the display device, the standard electrode is provided on one side of either the upper layer or the lower layer, the scanning electrode is provided on other side of the upper layer or the lower layer where the standard electrode is not provided, and the display color on the display surface side is changed by moving the conductive liquid toward the upper space side or the lower space side.

In this case, when applying the standard voltage and the selected voltage to the standard electrode and the scanning electrode, respectively, the conductive liquid can be moved toward the upper space side or the lower space side inside the liquid storage space without being deformed. Accordingly, the display color on the display surface side can be changed in a stable state.

Moreover, in the display device, a planar conductive film is used as the standard electrode.

In this case, the standard electrode can be formed easily, thereby reducing the manufacturing cost of the display device.

Moreover, in the display device, an insulating fluid that is not mixed with the conductive liquid is sealed movably inside the liquid storage space. In this case, a moving speed of the conductive liquid can be increased easily.

Moreover, in the display device, the standard electrode and the scanning electrode are provided on the upper layer or the lower layer, and the display color on the display surface side is changed by moving the conductive liquid toward the standard electrode side or the scanning electrode side. In this case, the standard electrode and the scanning electrode can be formed at the same time, thereby reducing the manufacturing cost of the display device easily. Moreover, the conductive liquid can be moved without being deformed, so that the display color on the display surface side can be changed in a stable state. Further, the conductive liquid is moved only inside the upper space or inside the lower space so as to change the display color, thereby decreasing a driving voltage of the conductive liquid.

Moreover, in the display device, the standard electrode and the scanning electrode are provided on one side of either the lower layer or the intermediate layer, and the signal electrode is provided on other side of the lower layer or the intermediate layer so as to face the standard electrode and the scanning electrode interposing the lower space.

In this case, since none of the standard electrode, the scanning electrode or the signal electrode is provided on the display surface side, an opening rate (effective display region) on the display surface side can be increased easily. Moreover, the signal electrode, the standard electrode and the scanning electrode face one another, thereby decreasing the driving voltage of the conductive liquid easily.

Moreover, in the display device, a first insulating fluid that is not mixed with the conductive liquid and a second insulating fluid that is not mixed with the conductive liquid and the first insulating fluid are sealed movably inside the liquid storage space, and the display color on the display surface side is changed by moving the first or second insulating fluid toward the upper space side.

In this case, the moving speed of the conductive liquid can be increased easily.

Moreover, in the display device, a first communication space that connects one end portion side of the upper space and one end portion side of the lower space, and a second communication space that connects other end portion side of the upper space and other end portion side of the lower space are provided in the liquid storage space.

In this case, when moving the conductive liquid, the conductive liquid can be circulated inside the liquid storage space, thereby increasing a changing speed of the display color on the display surface side easily. Moreover, in the display device, a dielectric layer is layered on surfaces of the standard electrode and the scanning electrode. In this case, an electric field that the dielectric layer applies to the conductive liquid can be increased reliably, thereby increasing the moving speed of the conductive fluid more easily.

Moreover, in the display device, the display surface side of the intermediate layer has a light scattering function.

In this case, external light that is incident from the outside is reflected by the above-described light scattering function so as to display white, thereby improving display quality of the white display easily.

Moreover, in the display device, a transparent sheet is used for the intermediate layer and the lower layer, and a backlight is provided on a back surface side of the lower layer.

In this case, the white display can be achieved by illumination light from the backlight, thereby improving the display quality of the white display easily. Moreover, since the backlight is used, the display operation can be performed even when the external light is not sufficient.

Moreover, in the display device, a transparent sheet is used for the intermediate layer, the lower layer includes a light scattering member and a transparent sheet that are provided in parallel, and a backlight is provided on a back surface side of the lower layer.

In this case, the white display can be performed by the illumination light from the light scattering member and the backlight, thereby improving the display quality of the white display easily. Moreover, since the external light is used in combination, thereby reducing power consumption of the backlight.

Moreover, the electric apparatus is an electric apparatus including a display portion that displays information including a letter and an image, wherein either one of the above-described display devices is used for the display portion.

In the electric apparatus structured as described above, the display device that can prevent the generation of the crosstalk is used for the display portion without providing the active element, so that the electric apparatus provided with the low-cost display portion having an excellent display function can be structured easily.

### EFFECTS OF THE INVENTION

The present invention can provide a display device that can prevent generation of a crosstalk without providing an active element, and an electric apparatus using the same.

### BRIEF DESCRIPTION OF DRAWINGS

FIG. 1 is a plan view explaining a display device according to Embodiment 1 of the present invention and an image display apparatus.

FIG. 2 is a cross-sectional view showing a structure of a main part of the display device during color display.

FIG. 3 is a cross-sectional view showing a structure of the main part of the display device during white display.

FIG. 4 is a view explaining an example of an operation of the display device.

FIG. 5 is a cross-sectional view showing a structure of a main part of a display device according to Embodiment 2 of the present invention.

FIG. 6 is a cross-sectional view showing a structure of a main part of a display device according to Embodiment 3 of the present invention.

FIG. 7A is a structural view schematically explaining an image display apparatus using a display device according to Embodiment 4, and FIG. 7B is a structural view schematically explaining a modified example of the image display apparatus shown in FIG. 7A.

FIG. 8 is a plan view explaining a display device according to Embodiment 5 of the present invention and an image display apparatus.

FIG. 9 is a cross-sectional view showing a structure of a main part of the display device shown in FIG. 8 during white display.

FIG. 10 is a cross-sectional view showing a structure of the main part of the display device shown in FIG. 8 during color display.

FIG. 11 is a view explaining steps of forming the standard electrode, the scanning electrode and the lower sheet shown in FIG. 8.

FIG. 12 is a view explaining steps of forming the signal electrode and the intermediate layer shown in FIG. 8.

FIG. 13 is a view explaining steps of forming the upper sheet shown in FIG. 8.

FIG. 14 is a view explaining a manufacturing step of combining the lower sheet and the intermediate layer.

FIG. 15 is a view explaining a final manufacturing step of the display device shown in FIG. 8.

FIG. 16 is a timing chart showing an example of an operation of the display device shown in FIG. 8.

FIG. 17 is a cross-sectional view showing a structure of a main part of a display device according to Embodiment 6 of the present invention.

FIG. 18 is a cross-sectional view showing a structure of a main part of the display device shown in FIG. 17 during color display.

FIG. 19 is a cross-sectional view showing a structure of a main part of a display device according to Embodiment 7 of the present invention.

FIG. 20 is a cross-sectional view showing a structure of a main part of a conventional display device and image display apparatus.

### DESCRIPTION OF THE INVENTION

Preferred embodiments of the display device and the electric apparatus of the present invention will be described below with reference to the drawings. It should be noted that, in the below description, the explanation will be provided by exemplifying a case of applying the present invention to an image display apparatus provided with a display portion that can display color images.

### Embodiment 1

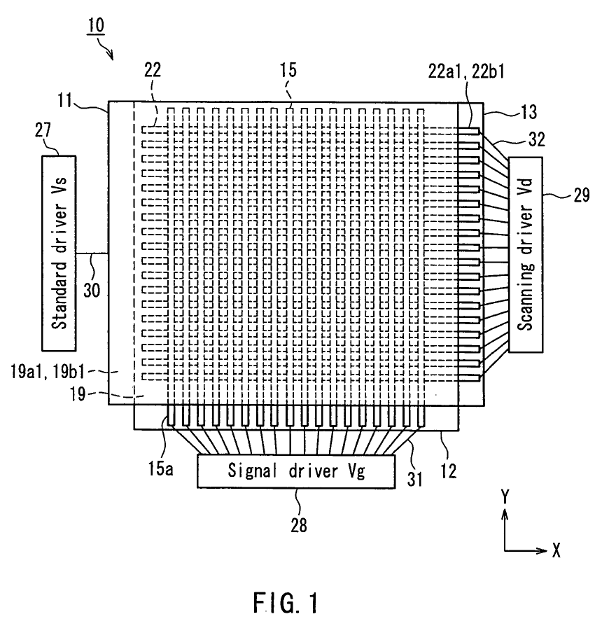

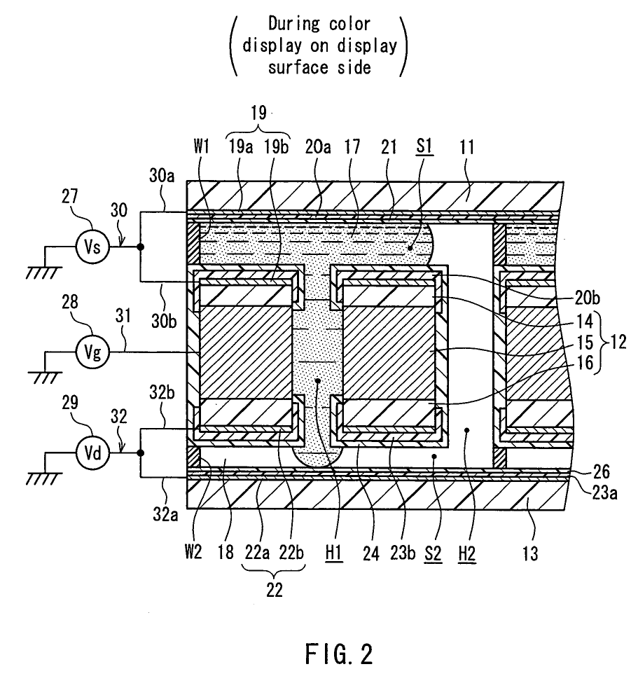

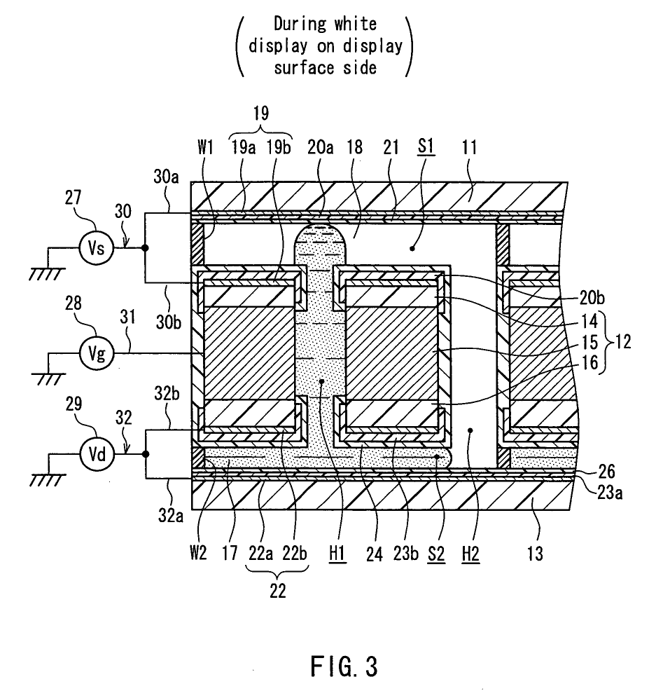

FIG. 1 is a plan view explaining a display device according to Embodiment 1 of the present invention and an image display apparatus. FIGS. 2 and 3 are cross-sectional views showing a structure of a main part of the display device during color display and white display, respectively.

In the figures, the image display apparatus of the present embodiment is provided with a display portion that is structured by using the display device of the present invention, and an upper side of this display portion in FIG. 2 is a display surface side that is observed by a user. As shown in FIG. 2, the display device is provided with an upper sheet 11, an intermediate layer 12 provided on a back surface side (non-display surface side) of the upper sheet 11 such that a predetermined upper space S1 is formed between the upper sheet 11 and the intermediate layer 12, and a lower sheet 13 provided on a back surface side of the intermediate layer 12 such that a predetermined lower space S2 is formed between the intermediate layer 12 and the lower sheet 13.

The upper sheet 11 is made of a transparent insulating material (for example, a synthetic resin material), and constitutes a transparent upper layer that is provided on the display surface side. For the lower sheet 13, an insulating material such as, for example, a synthetic resin is used, and the lower sheet 13 constitutes a lower layer. Further, in the display device, the upper space S1 and the lower space S2 are partitioned off by a plurality of partition walls W1 and W2 so as to have rectangular parallelepiped shapes, respectively, so that a plurality of pixel regions are provided on the display surface in a transverse direction of FIG. 2 and a direction perpendicular to the paper surface of FIG. 2. Moreover, each of the pixel regions is provided in each cross portion of a signal electrode 15 and a scanning electrode 22, which will be described below. Further, in the display device, the pixel regions for individual colors of R, G and B are provided so as to be adjacent to one another as a single picture element, for example, thus allowing a full-color display on the above-noted display surface side.

The intermediate layer 12 has a triple-layer structure including a light-scattering member 14, the signal electrode 15 and an insulating sheet 16 that are layered in this order from the display surface side. Moreover, in the intermediate layer 14, a pair of through holes H1 and H2 penetrating each pixel region in a thickness direction (vertical direction of FIG. 2) are formed. These through holes H1 and H2 constitute a first and second communication spaces, respectively, and one end sides of the respective through holes H1 and H2 are connected with the upper space S1. Moreover, other end sides of the respective through holes H1 and H2 are connected with the lower space S2. And, a sealed liquid storage space is formed in each pixel by the upper space S1, the lower space S2 and the through holes H1 and H2. Incidentally, alternatively to the above description, a structure of providing only one through hole (communication space) in each pixel may be adopted. Moreover, the display surface side of the intermediate layer 12 may have a light-scattering function, and other member than the light-scattering member 14 can also be used.

In the liquid storage space, an ionic conductive liquid (hereinafter, abbreviated as a “conductive liquid”) 17 that does not contain water and is colored and transparent and an insulating oil 18 are sealed. Moreover, in the adjacent two liquid storage spaces that are partitioned by the partition walls W1 and W2, the conductive liquids 17 that are colored in different colors are sealed. That is, a colorant such as a pigment and a dye in either of R, G or B is added to the conductive liquid 17, so that a display color on the display surface side can be displayed in a color corresponding to R, G or B. Moreover, the conductive liquid 17 is not limited to the ionic liquid, but an ionic liquid is preferably used because it has a vapor pressure of 0, excellent thermal stability and a high conductivity.

Specifically, the conductive liquid 17 is an ambient temperature molten salt formed of a 1-1 salt obtained by combining one kind of monovalent cation and one kind of monovalent anion, which is an ionic conductive liquid that does not contain water.

The cation and the anion are selected such that the conductive liquid 17 has combinations of a melting point, a viscosity and ion conductivity, which will be described below.

The conductive liquid 17 has a melting point within a range from −4° C. to −90° C. and is liquid at room temperature, and has a vapor pressure of 0 because it is nonvolatile, and has a broad liquid temperature region and excellent thermal stability.

The conductive liquid 17 has an ionic conductivity (s/cm) of 0.1×10⁻³ or more at room temperature (25° C.). The conductive liquid 17 has the viscosity of 300 cp or less at room temperature (25° C.).

The conductive liquid having the above-mentioned physical properties can contain a chemical species of 1-ethyl-3-methylimidazolium, 1-butyl-3-methylimidazolium or 1,2-dimethyl-3-propylimidazolium. The oil 18 has a property of not being mixed with the conductive liquid 17, and a non-polar oil containing one or plural kinds selected from the group consisting of side-chain higher alcohol, side-chain higher fatty acid, alkane, a silicone oil and a matching oil that are transparent is used as the oil 18.

Also, in the display device, for the purpose of applying a voltage to or removing a voltage from the conductive liquid 17 so as to move the conductive liquid 17 and replace it with the oil 18, the display device has a three-terminal structure for each pixel, which includes a standard electrode 19 that is provided on the upper space S1 side, a signal electrode 15 that is provided in the intermediate layer 12 and the scanning electrode 22 that is provided on the lower space S2 side.

In detail, on a lower surface of the upper sheet 11, an upper-side standard electrode 19a is provided so as to cover a whole of the display surface side of the upper space S1. Further, on the intermediate layer 12 side, a lower-side standard electrode 19b is provided on a surface facing the upper space S1 except openings of the through holes H1 and H2. These standard electrodes 19a and 19b are made of transparent planar conductive films such as ITO films or the like, and are connected electrically to each other. Incidentally, the standard electrode 19 may be provided at least on the upper sheet 11 among the upper sheet 11 and the intermediate layer 12. Incidentally, it is more preferable to provide two upper-side and lower-side layers of the standard electrodes 19a and 19b so as to interpose the upper space S1 in the point of increasing the moving speed of the conductive liquid 17 easily.

Moreover, on the upper surface of the lower sheet 13, a lower-side scanning electrode 22a is provided. Further, on the intermediate layer 12 side, an upper-side scanning electrode 22b is provided on a surface facing the lower space S2 except the openings of the through holes H1 and H2. For these scanning electrodes 22a and 22b, thin band-shaped conductive films are used, and the plurality of the scanning electrodes 22a and 22b are provided in stripe along the X direction of FIG. 1. Further, for these scanning electrodes 22a and 22b, the above-described conductive films made of aluminum, copper or the like are used, and they are formed by a vacuum evaporation method, a sputtering method, an ion plating method, a dip coating method or the like. Incidentally, the scanning electrode 22 may be provided at least on the lower sheet 13, among the lower sheet 13 and the intermediate layer 12. It should be noted that it is more preferable to provide two upper-side and lower-side layers of the scanning electrodes 22a and 22b so as to interpose the lower space S2 in the point of increasing the moving speed of the conductive liquid 17 easily.

In the intermediate layer 12, a plurality of the signal electrodes 15 are provided in stripe along the Y direction of FIG. 1, and are formed so as to cross the plurality of the scanning electrodes 22 as shown in FIG. 1. Thereby, in the display device, the signal electrodes 15 and the scanning electrodes 22 are arranged in matrix, and the conductive liquid 17 is moved by the electrowetting phenomenon so as to change the display color on the display surface side, as described below in detail.

Moreover, for the signal electrode 15, a thin band-shaped conductive film made of aluminum, copper or the like is used, and the signal electrode 15 is formed on the insulating sheet 16 using, for example, a synthetic resin material, by a vacuum evaporation method, a sputtering method, an ion plating method, a dip coating method or the like.

Moreover, as shown in FIG. 1, one end portion sides of the standard electrodes 19a, 19b, the signal electrode 15 and the scanning electrodes 22a, 22b are drawn to an outside of the effective display region of the display surface so as to form terminal portions 19a1, 19b1, 15a and 22a1, 22b1, respectively.

A standard driver 27 is connected with the terminal portions 19a1, 19b1 of the standard electrodes 19a, 19b via an upper-side wiring 30a (FIG. 2) and a lower-side wiring 30b (FIG. 2) of a wiring 30, respectively. The standard driver 27 constitutes a standard voltage applying portion, and is structured to apply a predetermined standard voltage Vs continuously to the standard electrode 19 in the case where the image display apparatus 10 displays information including a letter and an image on the display surface.

Moreover, a signal driver 28 is connected to terminal portions 15a of the plurality of the signal electrodes 15 via a plurality of wirings 31, respectively. The signal driver 28 constitutes a signal voltage applying portion, and is structured to apply a signal voltage Vg according to information to each of the plurality of the signal electrodes 15, in the case where the image display apparatus 10 displays the information including the letter and the image on the display surface.

A scanning driver 29 is connected with terminal portions 22a1, 22b1 of the plurality of the scanning electrodes 22a, 22b via a lower-side wiring 32a (FIG. 2) and an upper-side wiring 32b (FIG. 2) of a plurality of wirings 32, respectively. The scanning driver 29 constitutes a scanning voltage applying portion, and is structured to apply a scanning voltage Vd to each of the plurality of the scanning electrodes 22a, 22b, in the case where the image display apparatus 10 displays the information including the letter and the image on the display surface.

Moreover, when the standard driver 27 applies the standard voltage to the standard electrode 19, the scanning driver 29 applies, as the scanning voltage Vd, either one of a non-selected voltage that inhibits the movement of the conductive liquid 17 and a selected voltage that allows the conductive liquid 17 to move according to the signal voltage Vg, to each of a pair of upper-side and lower-side scanning electrodes 22a and 22b. And, the image display apparatus 10 is structured so that the pair of the upper-side and lower-side scanning electrodes 22a, 22b are selected, for example, in a direction from the upper side toward the lower side of FIG. 1 so as to perform the scanning operation in each line, thereby changing the display color on the display surface side into a display color according to the display information.

Moreover, the standard driver 27, the signal driver 28 and the scanning driver 29 include an alternating-current power supply or a direct-current power supply, thereby supplying the standard voltage Vs, the signal voltage Vg and the scanning voltage Vd that corresponds to the respective drivers.

Moreover, the standard driver 27 is structured to switch a polarity of the standard voltage Vs per every predetermined period of time. Moreover, the scanning driver 29 is structured to switch a polarity of the scanning voltages Vd (respective polarities of the non-selected voltage and the selected voltage) corresponding to the switch of the polarity of the standard voltage Vs. As described above, since the respective polarities of the standard voltage Vs and the scanning voltages Vd are switched per every predetermined period of time, localization of charges in the standard electrode 19 and the scanning electrode 22 can be prevented more, compared with the case of applying voltages with the same polarity constantly to the standard electrode 19 and the scanning electrode 22. Further, adverse effects such as display failures (after-image phenomenon) and deterioration of reliability (decrease of a life time) that are resulted from the localization of the charges can be prevented. That is, in the standard driver 27 and the scanning driver 29, the alternating-current power supply is used more preferably than the direct-current power supply, in the point of preventing the localization of the charges easily.

On surfaces of the standard electrodes 19a, 19b, dielectric layers 20a, 20b are layered, respectively. Moreover, on surfaces of the dielectric layers 20a, 20b, water-repellent films 21, 24 with insulating properties are respectively layered so as to be in contact with the conductive liquid 17 or the oil 18.

Similarly, on surfaces of the scanning electrodes 22a, 22b, dielectric layers 23a, 23b are layered, respectively. Moreover, on surfaces of the dielectric layers 23a, 23b, water-repellent films 26, 24 with insulating properties are respectively layered so as to be in contact with the conductive liquid 17 or the oil 18.

Moreover, in the signal electrode 15, a peripheral part of the through hole H1 is exposed so as to be in contact with the conductive liquid 17 directly. Moreover, on the periphery of the through hole H2, the water-repellent film 24 that is layered so as to cover both of the dielectric layers 20b, 23b is disposed. Further, this water-repellent film 24 is connected with the partition walls W1, W2 airtightly, thereby maintaining a sealing property of the liquid storage space of each pixel.

The dielectric layers 20a, 20b, 23a, 23b are formed of a high dielectric film containing parylene or aluminum oxide, for example, and have a layer thickness ranging from about 1 μm to 0.1 μm. Also, the water-repellent films 21, 24, 26 preferably become layers having an affinity for the conductive liquid 17 at the time of applying a voltage. More specifically, a fluorocarbon resin is preferable. Moreover, the dielectric layers 20a, 20b and the water-repellent films 21, 24 on the upper space S1 side are formed of transparent materials. Whereas, the signal electrode 15, the insulating sheet 16, the scanning electrode 22, the dielectric layers 23a, 23b and the water-repellent film 26 may be formed of transparent materials or opaque materials.

For the light-scattering member 14, a reflective sheet containing a transparent polymeric resin and plural kinds of fine particles that are added into the polymeric resin and are different in refractive index is used. Thus, when the conductive liquid 17 flows out from an inside of the upper space S1 and the transparent oil 18 flows therein, it is possible to display the display surface in white like a paper. More specifically, in the light-scattering member 14, the above-noted polymeric resin can be a thermoplastic resin or a thermosetting resin, for example, an epoxy resin, an acrylic resin, a polyimide resin, a polyamide resin, polycarbonate, Teflon (registered trademark) or the like. Also, in the light-scattering member 14, fine particles of titanium oxide or alumina having a large refractive index and hollow polymer fine particles having a small refractive index are contained as the above-noted plural kinds of fine particles. They cause diffusion on the surface of the light-scattering member 14, making it possible to achieve a color of white like a paper.

Alternatively to the above description, a light-scattering member using glass, ceramic or the like can also be used.

Moreover, the light-scattering member 14 has a thickness of preferably about 10 μm to 300 μm, more preferably 10 μm to 100 μm and particularly preferably about 50 μm. By setting the thickness of the light-scattering member 14 to be very small, which is 1 mm or less, as above, it becomes possible to structure a so-called paper display easily.

Further, the through holes H1, H2 have diameters of about 0.11 to 100 μm. Moreover, the through holes H1, H2 can be formed by a suitable method such as a photolithography method, an anodic oxidation method, an etching method, a dyeing method or a printing method.

The upper sheet 11 and the lower sheet 13 are formed of a thin sheet material similar to the light-scattering member 14 so as to have a thickness of about 10 μm to 300 μm. Also, each of intervals of the upper space S1 and the lower space S2 ranges from 5 μm to 50 μm, and preferably is about 10 μm in the vertical direction of FIG. 2. It should be noted that this interval is the corresponding dimension between the water-repellent films 26 and 24.

A displaying operation of the image display apparatus 10 structured as described above will be explained below specifically.

Voltages are applied to the standard electrodes 19, the scanning electrodes 22 and the signal electrodes 15 as described below, for example. That is, to each of the standard electrodes 19, the standard driver 27 applies a high voltage as the standard voltage Vs constantly. To the scanning electrodes 22, the scanning driver 29 applies a low voltage as the selected voltage one by one sequentially from the upper side of FIG. 1 such that it becomes a selected line so as to perform a scanning operation. Moreover, the scanning driver 29 applies the high voltage as the non-selected voltage to all of the remaining scanning electrodes 22 to which the low voltage is not applied, such that each of the remaining scanning electrodes 22 becomes a non-selected line. To each of the signal electrodes 15, the signal driver 28 applies the high voltage or the low voltage as the signal voltage Vg according to an image input signal from the outside.

In the case of performing the display operation as described above, combinations of the voltages to be applied to the standard electrode 19, the scanning electrode 22 and the signal electrode 15 are as shown in Table 1. Further, a behavior of the conductive liquid 17 and a display color on the display surface side correspond to the applied voltages as shown in Table 1. Incidentally, in Table 1, the high voltage and the low voltage are abbreviated as “H” and “L”, respectively (these abbreviations will be applied also in the tables below).

TABLE 1

| | | | | Behavior of |
|---|---|---|---|---|
| | | | | conductive liquid |
| | | | | and display color |
| | Standard | Signal | Scanning | on display surface |
| | electrode | electrode | electrode | side |
| Selected line | H | H | L | Move toward |
| | | | | lower space side |
| | | | | White display |
| | | L | | Move toward |
| | | | | upper space side |
| | | | | Color display |
| Non-selected | | H | H | Still (does not |
| line | | L | | move) |
| | | | | White display or |
| | | | | color display |

### <Operation in Selected Line>

In the selected line, when, for example, a high voltage is applied to the signal electrode 15, since the high voltage is applied to both of the standard electrode 19 and the signal electrode 15, a potential difference is not generated between the standard electrode 19 and the signal electrode 15. Whereas, since the low voltage is applied to the scanning electrode 22, a potential difference is generated between the signal electrode 15 and the scanning electrode 22. Thus, the conductive liquid 17 is drawn to the lower space S2 side where the scanning electrode 22 generating the potential difference from the signal electrode 15 is provided. As a result, the conductive liquid 17 is moved from the state shown in FIG. 2 into the state shown in FIG. 3 so as to be ejected from the upper space S1, so that the display color on the display surface side becomes in a state of white display resulted from the light-scattering member 14.

Moreover, the reason why the conductive liquid 17 is drawn between the electrodes that generate the potential difference as described above is because a charge distribution inside the conductive liquid 17 is changed (dielectricity is separated) by the potential difference between the electrodes, and a charge with a polarity that is opposite to the polarity of the respective corresponding electrodes is generated inside surfaces of the conductive liquid 17 on the sides of the respective electrodes. Inversely, in the case where no potential difference is generated between the electrodes, the charge distribution is not changed (dielectricity is not separated) inside the conductive liquid 17 unlike the above-described case, so that the conductive liquid 17 is not moved. Also in the below description, by a drawing phenomenon that is similar to the above, the conductive liquid 17 is moved toward the lower space S2 side or the upper space S1 side where the scanning electrode 22 or the standard electrode 19 that generate the potential difference from the signal electrode 15 is provided, respectively. Whereas, in the selected line, when a low voltage is applied to the signal electrode 15, a potential difference is generated between the standard electrode 19 and the signal electrode 15, and a potential difference is not generated between the signal electrode 15 and the scanning electrode 22. Thus, the conductive liquid 17 is drawn to the upper space S1 side where the standard electrode 19 generating the potential difference from the signal electrode 15 is provided. As a result, the conductive liquid 17 is moved from the state shown in FIG. 3 into the state shown in FIG. 2 so as to be filled in the upper space S1, so that the display color on the display surface side becomes in a state of the color display resulted from the conductive liquid 17.

### <Operation in Non-Selected Line>

In the non-selected line, when, for example, the high voltage is applied to the signal electrode 15, since the high voltage is applied to all of the standard electrode 19, the signal electrode 15 and the scanning electrode 22, no potential difference is generated between these electrodes. Thus, the conductive liquid 17 is maintained in a still state at a present position, that is, without being moved from the upper space S1 side or the lower space S2 side. As a result, the display color is maintained without being changed from the present state of white display or color display.

Similarly, in the non-selected line, even when the low voltage is applied to the signal electrode 15, the conductive liquid 17 is maintained in the still state at the present position, so that the present display color is maintained. That is, since the high voltage is applied both to the standard electrode 19 and the scanning electrode 22, a potential difference between the standard electrode 19 and the signal electrode 15 and a potential difference between the scanning electrode 22 and the signal electrode 15 are always the same.

As described above, in the non-selected line, regardless of whether the high voltage or the low voltage is applied to the signal electrode 15, the conductive liquid 17 is not moved but is still, so that the display color on the display surface side is not changed.

Whereas, in the selected line, the conductive liquid 17 can be moved according to the voltage applied to the signal electrode 15 as described above, so that the display color on the display surface side can be changed.

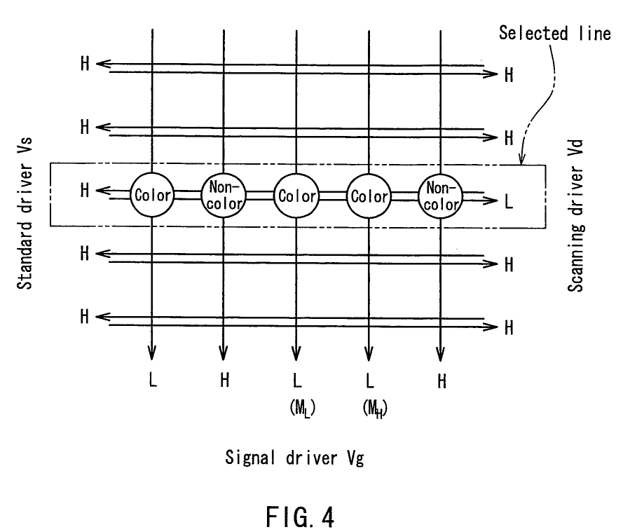

Moreover, in the image display apparatus 10, according to the combinations of the applied voltages shown in Table 1, the display color in each pixel on the selected line becomes a color or a non-color (white) based on the voltage applied to the signal electrode 15 that corresponds to each pixel, which is shown in FIG. 4, for example. Moreover, in the case where the scanning driver 29 performs the scanning operation with respect to the selected line of the scanning electrode 22, for example, from the upper side to the lower side of FIG. 4, the display color of each pixel in the display portion of the image display apparatus 10 is also changed sequentially from the upper side to the upper side of FIG. 4. Thus, the scanning driver 29 performs the scanning operation with respect to the selected line at a high speed, whereby the display color of each pixel in the display portion can also be changed at a high speed in the image display apparatus 10. Further, by applying the signal voltage Vg to the signal electrode 15 by synchronizing the scanning operation of the selected line, the image display apparatus 10 can display various information including a moving image, based on the image input signal from the outside.

Moreover, the combination of the voltages applied to the standard electrode 19, the scanning electrode 22 and the signal electrode 15 are not limited to those in Table 1, and may be the combinations shown in Table 2.

TABLE 2

| | | | | Behavior of |
|---|---|---|---|---|
| | | | | conductive liquid |
| | | | | and display color |
| | Standard | Signal | Scanning | on display surface |
| | electrode | electrode | electrode | side |
| Selected line | L | L | H | Move toward |
| | | | | lower space side |
| | | | | White display |
| | | H | | Move toward |
| | | | | upper space side |
| | | | | Color display |
| Non-selected | | L | L | Still (does not |
| line | | H | | move) |
| | | | | White display or |
| | | | | color display |

That is, to each of the standard electrodes 19, the standard driver 27 applies the low voltage as the standard voltage Vs constantly. To the scanning electrodes 22, the scanning driver 29 applies the high voltage as the selected voltage one by one sequentially from the upper side of FIG. 1 such that it becomes the selected line so as to perform the scanning operation. Moreover, the scanning driver 29 applies the low voltage as the non-selected voltage to all of the remaining scanning electrodes 22 to which the high voltage is not applied, such that each of the remaining scanning electrodes 22 becomes the non-selected line. To each of the signal electrodes 15, the signal driver 28 applies the high voltage or the low voltage as the signal voltage Vg according to the image input signal from the outside.

### <Operation in Selected Line>

In the selected line, when, for example, the low voltage is applied to the signal electrode 15, since the low voltage is applied to both of the standard electrode 19 and the signal electrode 15, a potential difference is not generated between the standard electrode 19 and the signal electrode 15. Whereas, since the high voltage is applied to the scanning electrode 22, a potential difference is generated between the signal electrode 15 and the scanning electrode 22. Thus, the conductive liquid 17 is drawn to the lower space S2 side where the scanning electrode 22 generating the potential difference from the signal electrode 15 is provided. As a result, the conductive liquid 17 is moved from the state shown in FIG. 2 into the state shown in FIG. 3 so as to be ejected from the upper space S1, so that the display color on the display surface side becomes in a state of white display resulted from the light-scattering member 14.

Whereas, in the selected line, when the high voltage is applied to the signal electrode 15, a potential difference is generated between the standard electrode 19 and the signal electrode 15, and a potential difference is not generated between the signal electrode 15 and the scanning electrode 22. Thus, the conductive liquid 17 is drawn to the upper space S1 side where the standard electrode 19 generating the potential difference from the signal electrode 15 is provided. As a result, the conductive liquid 17 is moved from the state shown in FIG. 3 into the state shown in FIG. 2 so as to be filled in the upper space S1 so that the display color on the display surface side becomes in a state of the color display resulted from the conductive liquid 17.

### <Operation in Non-Selected Line>

In the non-selected line, when, for example, the low voltage is applied to the signal electrode 15, since the low voltage is applied to all of the standard electrode 19, the signal electrode 15 and the scanning electrode 22, and no potential difference is generated between these electrodes. Thus, the conductive liquid 17 is maintained in a still state at a present position, that is, without being moved from the upper space S1 side or the lower space S2 side. As a result, the display color is maintained without being changed from the present state of the white display or the color display.

Similarly, in the non-selected line, even when the high voltage is applied to the signal electrode 15, the conductive liquid 17 is maintained in the still state at the present position, so that the present display color is maintained. That is, since the low voltage is applied to both of the standard electrode 19 and the scanning electrode 22, a potential difference between the standard electrode 19 and the signal electrode 15 and a potential difference between the scanning electrode 22 and the signal electrode 15 are always the same.

As described above, even in the case shown in Table 2, in the non-selected line, regardless of whether the high voltage or the low voltage is applied to the signal electrode 15, the conductive liquid 17 is not moved but is still, so that the display color on the display surface side is not changed, which is similar to the case shown in Table 1.

Whereas, in the selected line, the conductive liquid 17 can be moved according to the voltage applied to the signal electrode 15 as described above, so that the display color on the display surface side can be changed.

Here, the standard voltage Vs that can determine the selected line and the non-selected line, and the scanning voltage Vd will be described specifically below.

That is, the selected voltage to be applied to the scanning electrode 22 in the selected line may be a voltage that can move the conductive liquid 17 by the electrowetting phenomenon according to the potential difference from the standard voltage Vs applied to the standard electrode 19. Whereas, the voltage applied to the scanning electrode 22 in the non-selected line may be a voltage that is substantially equal to the standard voltage Vs applied to the standard electrode 19 such that the conductive liquid 17 is not moved by the potential difference from the standard voltage Vs.

More specifically, where a threshold value voltage that is necessary for moving the conductive liquid 17 is denoted by Vth, and the selected voltage is denoted by Vd1, this selected voltage Vd1 is set such that an absolute value of a difference between the selected voltage Vd1 and the standard voltage Vs is the threshold value voltage Vth or more, whereby the conductive liquid 17 can be moved.

Whereas, where the non-selected voltage is denoted by Vd2, this non-selected voltage Vd2 is set such that an absolute value of a difference between the non-selected voltage Vd2 and the standard voltage Vs is less than the threshold value voltage Vth, whereby the conductive liquid 17 can stand still without being moved.

Moreover, in the present embodiment, other than the combinations of the applied voltages shown in Tables 1 and 2, the voltage to be applied to the signal electrode 15 is not limited to the two values of only the high voltage or the low voltage, and may be varied to be in multiple levels by setting, for example, a mid(low) voltage a the mid(high) voltage as described below.

### <Operation for Applying Mid(Low) Voltage>

As illustrated in FIG. 4, as the mid(low) voltage (hereinafter, called a “ML voltage”) that is a voltage between the high voltage and the low voltage and closer to the low voltage, for example, the ML voltage (=⅓×(high voltage−low voltage)+low voltage) is applied to a signal electrode 15 at the center. In this case, the potential difference between the standard electrode 19 and the signal electrode 15 is smaller than the potential difference in the case of the low voltage. Thus, in a pixel where the ML voltage is applied to the signal electrode 15, a moving amount of the conductive liquid 17 toward the upper space S1 side is smaller than a moving amount at the time of applying the low voltage. Thus, the display color of the pixel to which the ML voltage is applied can be a color that is middle of the colors during the color display and during the white display.

### <Operation for Applying Mid(High) Voltage>

Moreover, as the mid(high) voltage (hereinafter, called a “MH voltage”) that is a voltage between the high voltage and the low voltage and closer to the high voltage, for example, the MH voltage (=⅔×(high voltage−low voltage)+low voltage) is applied to a second signal electrode 15 from a right end in FIG. 4. In this case, the potential difference between the standard electrode 19 and the signal electrode 15 is smaller than the potential difference in the case of the ML voltage. Thus, in a pixel where the MH voltage is applied to the signal electrode 15, a moving amount of the conductive liquid 17 toward the upper space S1 side is smaller than a moving amount at the time of applying the ML voltage. Thus, the display color of the pixel to which the MH voltage is applied can be a color that is middle between the color during the color display at the time of applying the ML voltage and the color during the white display. In particular, in this case, the potential difference between the standard electrode 19 and the signal electrode 15 (=high voltage−MH voltage) and the potential difference between the signal electrode 15 and the scanning electrode 22 (=MH voltage−low voltage) satisfy a relationship (high voltage−MH voltage<MH voltage−low voltage). Thus, in the pixel where the MH voltage is applied to the signal electrode 15, the conductive liquid 17 is drawn to the lower space S2 side where the scanning electrode 22 having the larger potential difference is provided.

As described above, by allowing the voltage to be applied to the signal electrode 15 to be in multiple levels of two values or more, a color tone of the pixel can be varied in the multiple levels. That is, the image display apparatus 10 can perform gradation display by controlling the signal voltage Vg. Incidentally, the above description has been directed to the case where the voltage value within the ranges of the selected voltage and the non-selected voltage are applied to the signal electrode 15, but a voltage value out of the above-described range can also be applied as the signal voltage Vg.

In the present embodiment with the above-described structure, the plurality of the signal electrodes 15 and the plurality of the scanning electrodes 22 are provided so as to cross each other, thereby being arranged in matrix. Moreover, when the standard driver (standard voltage applying portion) 27 applies the standard voltage Vs to the standard electrode 19, the scanning driver (scanning voltage applying portion) 29 applies, to each of the plurality of the scanning electrodes 22, either one of the non-selected voltage that inhibits the movement of the conductive liquid 17 inside the liquid storage space and the selected voltage that allows the conductive liquid 17 to move inside the liquid storage space according to the signal voltage Vg. That is, in the present embodiment, the non-selected voltage is applied to the scanning electrode 22 except for the one selected line, whereby the non-selected line that inhibits the movement of the conductive liquid 17 can be set, so that the generation of a crosstalk can be prevented without providing the active element to each pixel. As a result, in the present embodiment, it is possible to structure the display device and the image display apparatus 10 with simple configurations at low costs, and to provide the display device and the image display apparatus 10 with high performances that can prevent degradation of contrasts and display quality caused by the crosstalk.

Moreover, in the present embodiment, the standard electrode 19 and the scanning electrode 22 are provided on the upper sheet (upper layer) 11 and the lower sheet (lower layer) 13, respectively. Further, the display color on the display surface side is changed by moving the conductive liquid 17 toward the upper space S1 side or the lower space S2 side. Thereby, in the present embodiment, when the standard voltage and the selected voltage are applied to the standard electrode 19 and the scanning electrode 22, respectively, the conductive liquid 17 can be moved toward the upper space side or the lower space side inside the liquid storage space without being deformed. Accordingly, the display color on the display surface side can be changed in a stable state.

### Embodiment 2

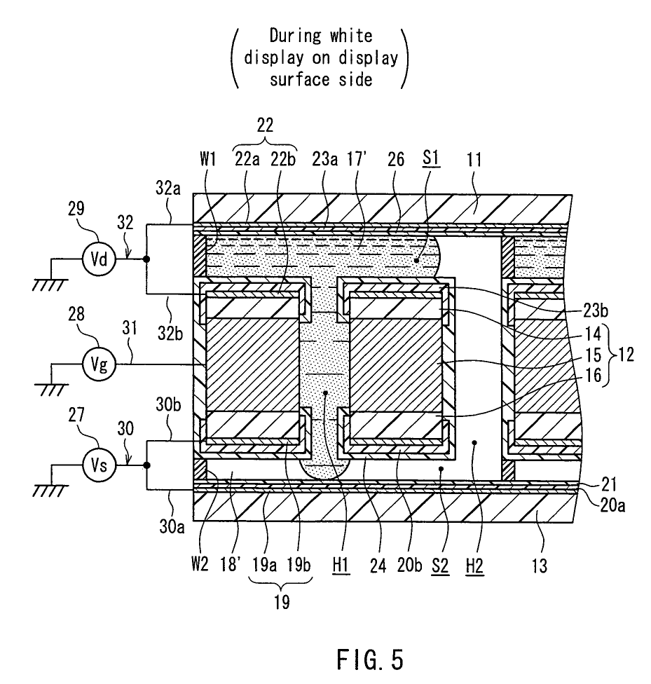

FIG. 5 is a cross-sectional view showing a structure of a main part of the display device according to Embodiment 2 of the present invention. In the figure, a main distinctive point of the present embodiment from above-described Embodiment 1 lies in the provision of the standard electrode and the scanning electrode on the lower space side and the upper space side, respectively. Incidentally, elements provided in common with Embodiment 1 described above are given the same reference numerals, and the redundant description thereof will be omitted here.

That is, as shown in FIG. 5, in the present embodiment, the standard electrode 19 is provided on the lower space S2 side, and the scanning electrode 22 is provided on the upper space S1 side. Moreover, a conductive liquid 17′ of the present embodiment is not a colored liquid that is colored in a predetermined color, but is a light-scattering liquid. In detail, not a pigment or the like but light-scattering particles such as titanium oxide particles or hollow particles are mixed into the conductive liquid 17′, thereby allowing the conductive liquid 17′ to be the light-scattering liquid that scatters and reflects external light. Then, as shown in FIG. 5, when the conductive liquid 17′ is moved toward the upper space S1 side, the display color on the display surface side becomes white.

Whereas, a pigment or the like in a color of either of R, G and B is added to an oil 18′, so that, when the oil 18′ is moved toward the upper space S1 side according to the movement of the conductive liquid 17′, the display color on the display surface side becomes the color corresponding to R, G or B. According to the structure described above, the present embodiment can achieve effects similar to those of above-described Embodiment 1. Incidentally, in the present embodiment, the white display is achieved by the light-scattering particles contained in the conductive liquid 17′ as described above, a transparent or opaque insulating material may also be used instead of the light-scattering member 14.

Incidentally, the combination of the conductive liquid and the oil is not limited to those of Embodiments 1 and 2 described above, and may be any combination selected from: a colored conductive liquid and a colored oil; a colored conductive liquid and a transparent oil; a colored conductive liquid and a white oil resulted from the light-scattering particles; a transparent conductive liquid and a colored oil; a transparent conductive liquid and a white oil resulted from the light-scattering particles; a white conductive liquid resulted from the light-scattering particles and a colored oil; and a white conductive liquid resulted from the light-scattering particles and a transparent oil.

### Embodiment 3

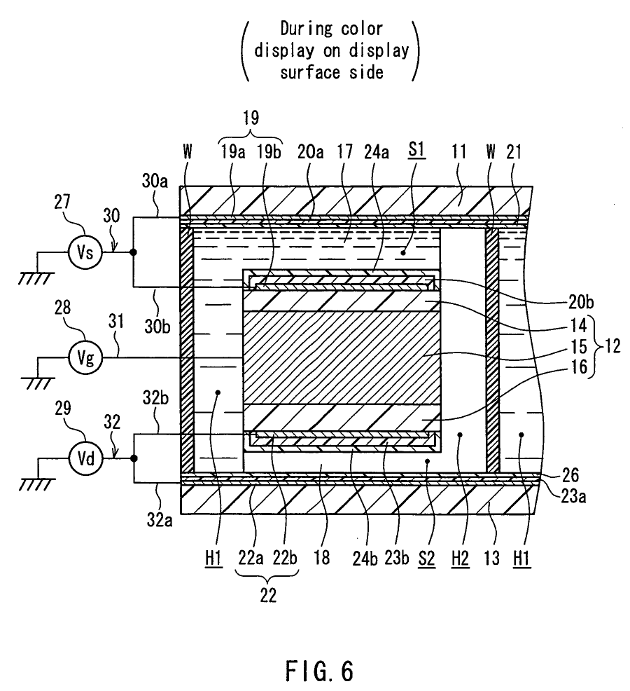

FIG. 6 is a cross-sectional view showing a structure of a main part of the display device according to Embodiment 3 of the present invention. In the figure, a main distinctive point of the present embodiment from above-described Embodiment 1 lies in the provision of a first communication space that connects one end portion side of the upper space and one end portion side of the lower space, and a second communication space that connects other end portion side of the upper space and other end portion side of the lower space. Incidentally, elements provided in common with Embodiment 1 described above are given the same reference numerals, and the redundant description thereof will be omitted here.

That is, as shown in FIG. 6, in the present embodiment, an upper end portion and a lower end portion of the through hole H1 are formed so as to be connected with left end portion sides of the upper space S1 and the lower space S2, respectively. Moreover, an upper end portion and a lower end portion of the through hole H2 are formed so as to be connected with right end portion sides of the upper space S1 and the lower space S2, respectively. And, in the present embodiment, as shown in FIG. 6, a cross section of the above-described liquid storage space in each pixel is formed to have a frame shape.

According to the above-described structure, the present embodiment can achieve effects similar to those of Embodiment 1 described above. Moreover, in the present embodiment, since the cross section of the liquid storage space is formed to have the frame shape, the conductive liquid 17 can be circulated easily inside the liquid storage space when being moved therein, thereby making it possible to increase the changing speed of the display color on the display surface side easily.

### Embodiment 4

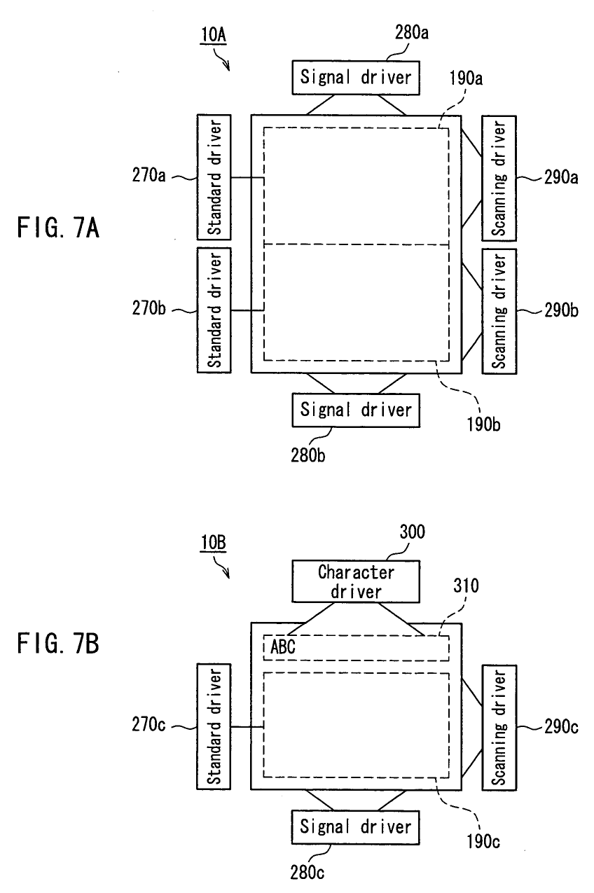

FIG. 7A is a structural view schematically explaining an image display apparatus using a display device according to Embodiment 4. In the figure, a main distinctive point of the present embodiment from above-described Embodiment 1 lies in dividing the standard electrode into a plurality of regions. Incidentally, elements provided in common with Embodiment 1 described above are given the same reference numerals, and the redundant description thereof will be omitted here.

That is, as shown in FIG. 7A, in an image display apparatus 10A of the present embodiment, two standard electrodes 190a and 190b are used such that the display surface of the display portion can be divided vertically into two regions. Moreover, as drivers corresponding to a region of the standard electrode 190a, a standard driver 270a, a signal driver 280a and a scanning driver 290a are provided. And, the standard driver 270a applies the standard voltage Vs to the standard electrode 190a, and the signal driver 280a and the scanning driver 290a apply the signal voltage Vg and the scanning voltage Vd to the signal electrode 15 and the scanning electrode 22 that are provided in the region of the standard electrode 190a, respectively. Similarly, as drivers corresponding to the region of the standard electrode 190b, a standard driver 270b, a signal driver 280b and a scanning driver 290b are provided. And, the standard driver 270b applies the standard voltage Vs to the standard electrode 190b, and the signal driver 280b and the scanning driver 290b apply the signal voltage Vg and the scanning voltage Vd to the signal electrode 15 and the scanning electrode 22 that are provided in the region of the standard electrode 190b, respectively.

According to the above-described structure, the present embodiment can achieve effects similar to those of Embodiment 1 described above. Moreover, in the present embodiment, since the standard driver, the signal driver and the scanning driver are provided in each of the regions of the standard electrodes, processing loads of the respective drivers can be reduced. Also, it can be applied to the image display apparatus with the increased size (increased screen size) easily.

Incidentally, the above description has been directed to the case of dividing the standard electrode into the two regions, but the number of the regions of the standard electrode is not limited to this. Also, as shown in FIG. 7B, it is possible to set a region for displaying predetermined information.

That is, in FIG. 7B, in an image display apparatus 10B, a predetermined frame on the upper side, and a character display region 310 for displaying characters such as letters (for example, “ABC”) are set. This character display region 310 is a region for either displaying or non-displaying the characters simply, and is provided with a character driver 300 for allowing the character display region 310 to display or non-display the characters selectively.

Further, in the image display apparatus 10B, a standard electrode 190c is provided on a lower side of the character display region 310. And, in this image display apparatus 10B, a standard driver 270c, a signal driver 280c and a scanning driver 290c are provided so as to correspond to a region of the standard electrode 190c, whereby this image display apparatus 10B can display information according to the image input signal, similarly to each of the above-described embodiments.

Incidentally, each of above-described Embodiments 1 to 4 has provided the example of using the planar conductive film as the standard electrode, but a band-shaped conductive film may also be used. However, it is preferable to use the planar conductive film as the above-described embodiments, because it is possible to simplify a step of forming the standard electrode and form the standard electrode easily, thereby reducing the cost for manufacturing the display device and the image display apparatus.

### Embodiment 5

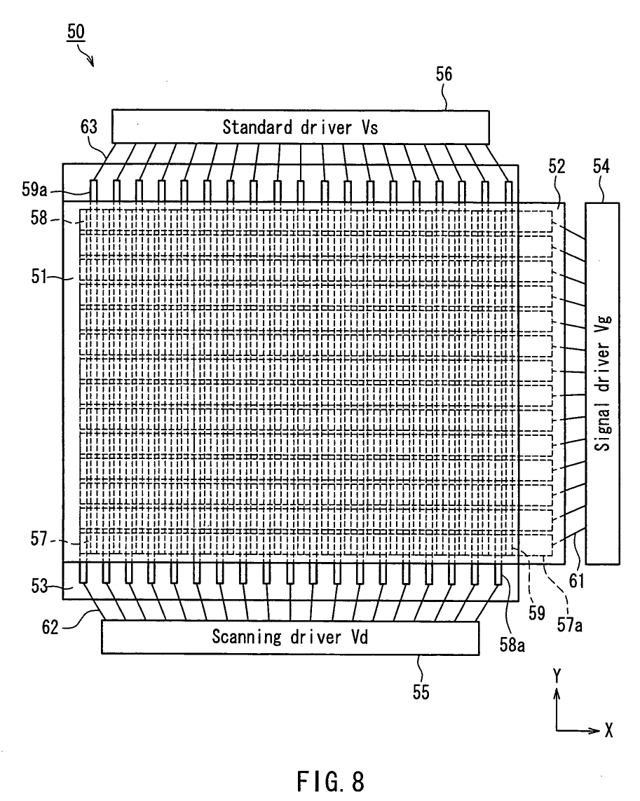

FIG. 8 is a plan view explaining a display device according to Embodiment 5 of the present invention and an image display apparatus. In the figure, a main distinctive point of the present embodiment from above-described Embodiment 1 lies in the provision of band-shaped standard electrodes and band-shaped scanning electrodes alternately on the lower sheet. Incidentally, elements provided in common with Embodiment 1 described above are given the same reference numerals, and the redundant description thereof will be omitted here.

That is, as shown in FIG. 8, in an image display apparatus 50 of the present embodiment, a plurality of signal electrodes 57 are provided in stripe along an X direction. Moreover, in the image display apparatus 50, a plurality of scanning electrodes 58 and a plurality of standard electrodes 59 are provided alternately in stripe along a Y direction. Further, as each of the signal electrodes 57, the scanning electrodes 58 and the standard electrodes 59, a band-shaped conductive film made of aluminum or the like is used. Moreover, the plurality of the signal electrodes 57 and the plurality of the scanning electrodes 58 are provided so as to cross each other, and pixel regions are set in cross portions of the signal electrodes 57 and the scanning electrodes 58.

Moreover, one end portion sides of the signal electrode 57, the scanning electrode 58 and the standard electrode 59 are drawn to the outside of the effective display region of the display surface so as to form terminal portions 57a, 58a and 59a, respectively.

A signal driver 54 is connected with the terminal portion 57a of the signal electrode 57 via a wiring 61, so that the signal voltage Vg according to the display information is applied thereto, similarly to that of the above-described embodiments.

Moreover, a scanning driver 55 is connected with the terminal portion 58a of the scanning electrode 58 via the wiring 62, so that the scanning voltage Vd is applied similarly to that of the above-described embodiments, thereby performing the scanning operation. That is, the scanning driver 55 can apply, as the scanning voltage Vd, either one of the non-selected voltage that inhibits the movement of the conductive liquid 17 inside the liquid storage space and the selected voltage that allows the conductive liquid 17 to move inside the liquid storage space according to the signal voltage Vg. And, the scanning driver 55 applies the selected voltages sequentially to the respective scanning electrodes 58, for example, from a left side to a right side of the figure, thereby performing the scanning operation similar to that of the above-described embodiments.

The standard driver 56 is connected with a terminal portion 59a of the standard electrode 59 via a wiring 63, so that the predetermined standard voltage Vs is applied thereto similarly to that of the above-described embodiments.

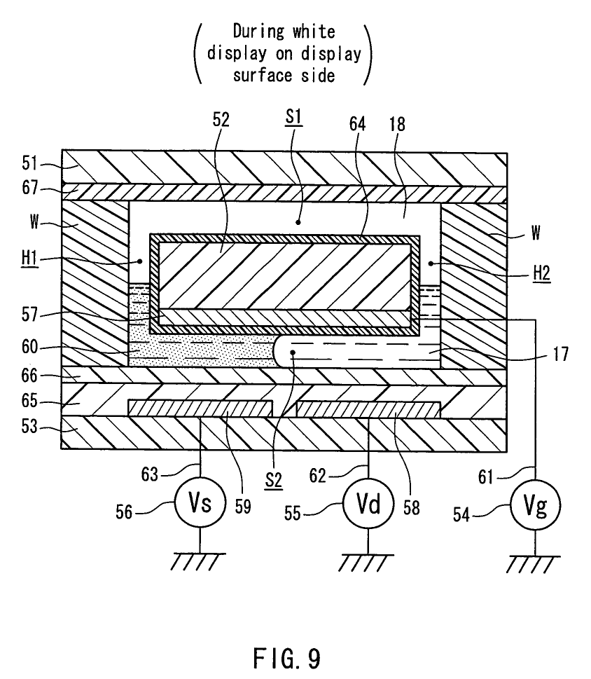

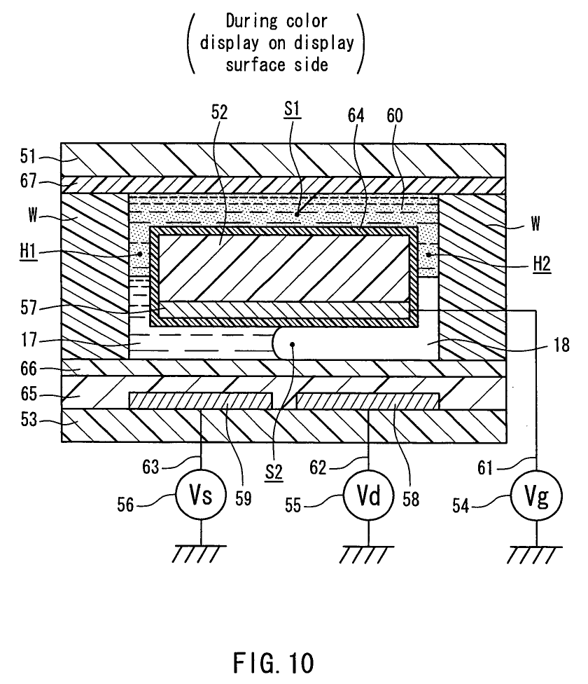

Moreover, the scanning electrode 58 and the standard electrode 59 are provided on the lower sheet 53 side, and the signal electrode 57 is provided on the intermediate layer side so as to face the scanning electrode 58 and the standard electrode 59 interposing the lower space S2. More specifically, by also referring to FIGS. 9 and 10, a transparent upper sheet 51 is provided on the display surface side, and a transparent water-repellent film 67 is layered on the upper space S1 side of this upper sheet 51.

Moreover, the scanning electrode 58 and the standard electrode 59 are provided in parallel on a surface of the lower sheet 53 on the display surface side, and a dielectric layer 65 and a water-repellent film 66 are layered in this order on the scanning electrode 58 and the standard electrode 59.

Moreover, the signal electrode 57 is formed on a surface of a light-scattering member 52 on a non-display surface side, and the light-scattering member 52 and the signal electrode 57 are covered with a water-repellent film 64, thereby constituting an intermediate layer.

Moreover, a cross section of the liquid storage space constituted of the upper space S1, the lower space S2 and the through holes H1, H2 has a frame shape, similarly to that of Embodiment 3 described above. That is, the upper end portion and the lower end portion of the through hole H1 are connected with left end portion sides of the upper space S1 and the lower space S2, respectively, and the upper end portion and the lower end portion of the through hole H2 are connected with the right end portion sides of the upper space S1 and the lower space S2, respectively. Further, adjacent pixels are partitioned by a partition wall W, and the liquid storage space of each of the pixel regions is sealed airtightly.

Moreover, inside the liquid storage space, the conductive liquid 17, the oil 18 as a first insulating fluid and water 60 as a second insulating fluid are sealed movably. The water 60 is colored in either color of R, G or B by a pigment, a dye or the like. It should be noted that this water 60 does not contain any electrolyte, and thus functions as the second insulating fluid as described above. That is, the water 60 itself does not move even when the voltage corresponding to the above-described electrode such as the scanning electrode 58 is applied, thereby not affecting the driving of the display device, which is different from the conductive liquid 17.

Whereas, the conductive liquid 17 is formed such that it can slide between the scanning electrode 58 and the standard electrode 59, and is moved toward either one side of the scanning electrode 58 side and the standard electrode 59 side so as to perform white display or color display resulted from the water 60, as shown in FIGS. 9 and 10, respectively (detail will be described below).

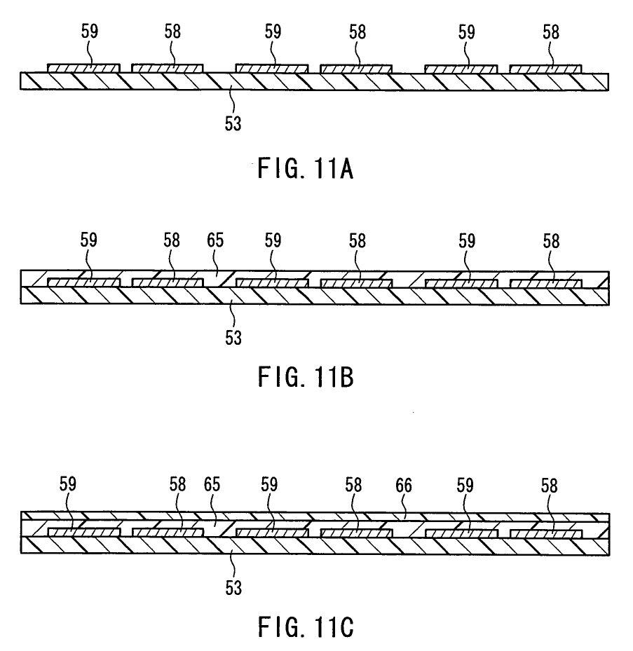

Here, by referring to FIGS. 11 to 15, a process for manufacturing the display device of the present embodiment will be described below specifically.

Firstly, a step of forming the lower sheet 53 will be described with reference to FIG. 11.

In FIG. 11A, as the lower sheet 53, for example, a non-alkali glass substrate (produced by Asahi Glass Co. Ltd.) with a thickness of 0.7 mm is used, and an ITO film with a film thickness of 100 nm is formed on the lower sheet 53 by a sputtering method, thereby forming the scanning electrode 58 and the standard electrode 59. Also, the scanning electrode 58 and the standard electrode 59 may be opaque metal foils that are not made of a transparent ITO film.

Thereafter, as shown in FIG. 11B, on an upper side of the lower sheet 53, the scanning electrode 58 and the standard electrode 59, an amorphous titanium oxide Ti-44 (produced by RASA INDUSTRIES, LTD.) was formed as the dielectric layer 65 by a spin coating method. A film thickness of this dielectric layer 65 was 200 nm.

Then, as shown in FIG. 11C, a water-repellent film FG-5010 produced by Fluoro Technology was applied to a surface of the dielectric layer 65 by a dipping method or a spin coating method, and was burnt at 80° C. for 30 minutes, thereby forming the water-repellent film 66. A film thickness of the water-repellent film 66 was 20 nm.

As described above, since the scanning electrode 58 and the standard electrode 59 are formed by being patterned on the same substrate at the same time, the process for manufacturing the display device can be simplified more than that of the above-described embodiment, thereby reducing the cost.

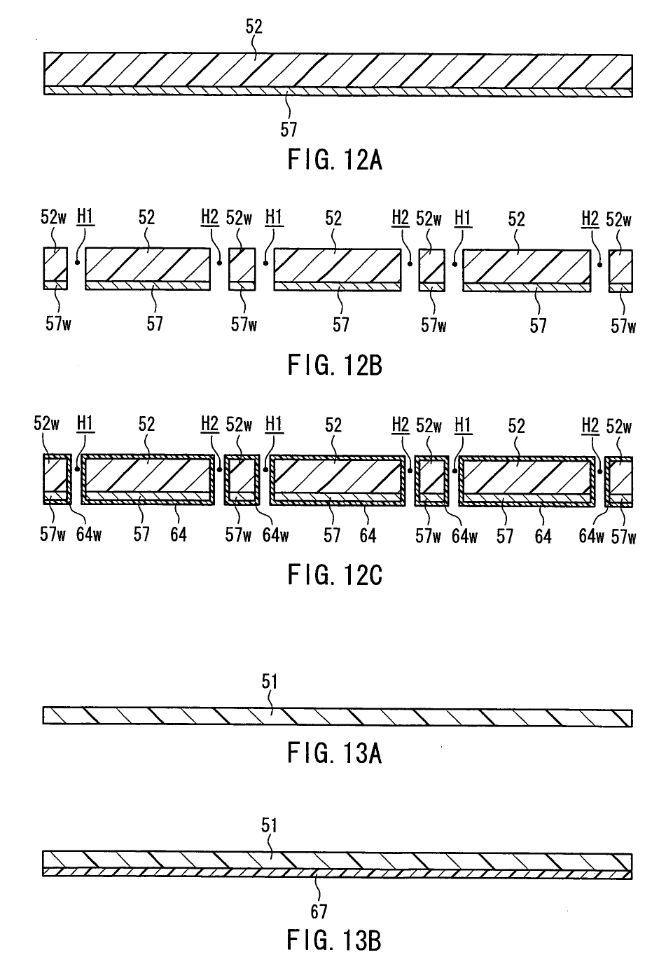

Subsequently, a step of forming the intermediate layer will be described specifically with reference to FIG. 12.

In FIG. 12A, for the light-scattering member 52, for example, a reflective sheet (thickness: 30 μm) produced by FUJICOPIAN CO., LTD was used. This light-scattering member 52 was obtained by kneading fine particles made of titanium oxide into a PET resin, thereby achieving white resulted from the fine particles of the titanium oxide. Moreover, on a surface of the light-scattering member 52, aluminum was evaporated so as to provide a film thickness of 100 nm, thereby forming the signal electrode 57. As this signal electrode 57, a transparent electrode may be used, but this time, aluminum was used in order to increase a reflectivity because the film thickness of the light-scattering member 52 is small.

Next, as shown in FIG. 12B, the through holes H1, H2 with a width of 30 μm and a depth of 30 μm were formed by performing an excimer laser processing using a mask in which a multiple number of holes were formed. Incidentally, the through holes H1, H2 can also be provided by a micro-drill processing method instead of the excimer laser processing.

Next, as shown in FIG. 12C, a water-repellent film produced by Fluoro Technology was formed on the surfaces of the light-scattering member 52 and the signal electrode 57 by a dipping method so as to provide the water-repellent film 64. Incidentally, a light-scattering member 52w, a signal electrode 57w and a water-repellent film 64w between the through holes H1, H2 are integrated with a spacer described below so as to be made the partition wall W.

Subsequently, a step of forming the upper sheet 51 will be described with reference to FIG. 13.

In FIG. 13A, as the upper sheet 51, for example, a non-alkali glass substrate (produced by Asahi Glass Co. Ltd.) with a thickness of 0.7 mm is used. And, as shown in FIG. 13B, a water-repellent film produced by Fluoro Technology was formed on the surface of the upper sheet 51 by a dipping method or a spin coating method, thereby forming the water-repellent film 67. Also, instead of the non-alkali glass substrate, a transparent resin sheet may be used as the upper sheet 51, and a resin sheet may be used as the lower sheet 53.

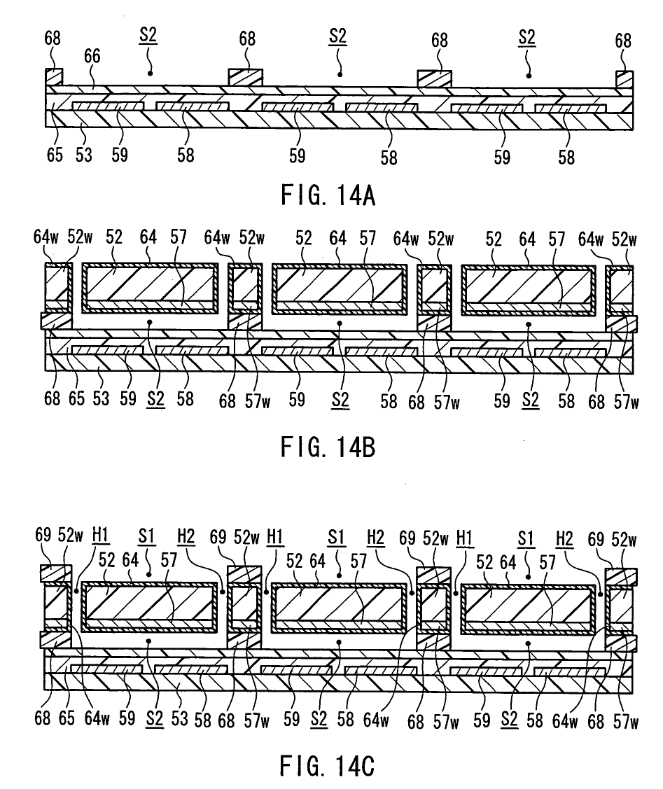

Next, a manufacturing step of combining the lower sheet 53 and the intermediate layer will be described with reference to FIG. 14.

In FIG. 14A, a resin spacer 68 using a white UV curable resin was formed on a surface of the water-repellent film 66. A width and a height of this resin spacer 68 were 10 μm. Thereby, the lower space S2 with a gap of 10 μm was formed on the surface of the water-repellent film 66.

That is, as shown in FIG. 14B, by mounting a light-scattering member 52w, a signal electrode 57w and a water-repellent film 64w of the intermediate layer on the resin spacer 68, the lower space S2 was formed between the water-repellent film 66 and the intermediate layer.

And, as shown in FIG. 14B, a resin spacer 69 using a white UV curable resin was provided on an upper side of the water-repellent film 64w. A width and a height of this resin spacer 69 were 10 μm. Thereby, the upper space S1 with a gap of 10 μm was formed on an upper side of the intermediate layer. Thereafter, the signal electrode 57, the scanning electrode 58 and the standard electrode 59 were connected with the signal driver 54, the scanning driver 55 and the standard driver 56, respectively. Incidentally, the scanning driver 55 and the standard driver 56 were structured such that they could apply voltages of AC 3.5 V at a frequency of 10 kHz, for example.

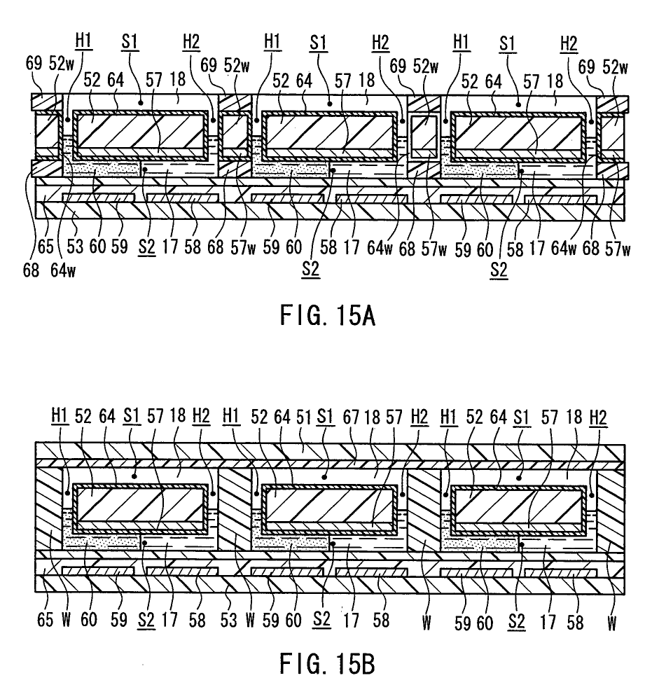

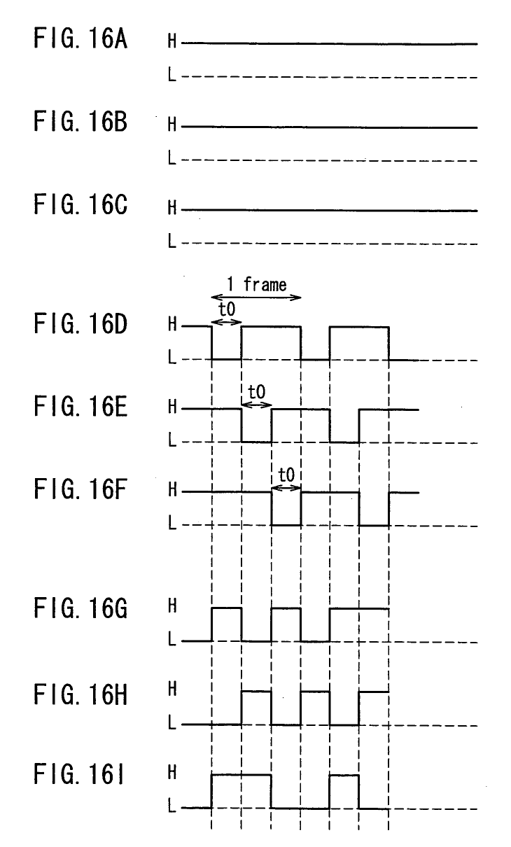

Next, a final step of manufacturing the display device will be described with reference to FIG. 15.

In FIG. 15A, a conductive liquid (produced by Koei Chemical Co., Ltd.; trade name: IL-A4) 17, which was an ambient temperature molten salt made of aliphatic amine and was a nonaqueous solution, the oil (produced by Kishida Chemical Co., Ltd., n-dodecane) 18 and the water 60 that were not mixed with one another were filled into the liquid storage space of each of the pixel regions. Thereafter, the water 60 was colored in any of R, G and B, by dispersing a predetermined pigment thereto.

Subsequently, as shown in FIG. 15B, the upper sheet 51 was attached to an upper side of the resin spacer 69 such that the water-repellent film 67 was in contact with the spacer 69, thereby completing the display device.

A display operation in the present embodiment with the above-described structure will be described below specifically.

For example, voltages are applied to the standard electrode 59, the scanning electrode 58 and the signal electrode 57 as described below. That is, to the standard electrode 59, the standard driver 56 applies the high voltage as the standard voltage Vs constantly. To the scanning electrodes 58, the scanning driver 55 applies the low voltage as the selected voltage one by one sequentially from a left side of FIG. 8 such that it becomes the selected line, thereby performing the scanning operation. Moreover, the scanning driver 55 applies the high voltage as the non-selected voltage to all of the remaining scanning electrodes 58 to which the low voltage is not applied, such that each of the remaining scanning electrodes 58 becomes the non-selected line. To the signal electrode 57, the signal driver 54 applies the high voltage or the low voltage as the signal voltage Vg according to the image input signal from the outside.

In the case of performing the display operation as described above, combinations of the voltages to be applied to the standard electrode 59, the scanning electrode 58 and the signal electrode 57 are as shown in Table 3. Further, a behavior of the conductive liquid 17 and a display color on the display surface side correspond to the applied voltages as shown in Table 3.

TABLE 3

| | | | | Behavior of |
|---|---|---|---|---|
| | | | | conductive liquid |
| | | | | and display color |
| | Standard | Signal | Scanning | on display surface |
| | electrode | electrode | electrode | side |
| Selected line | H | H | L | Move toward |
| | | | | scanning electrode |
| | | | | side |
| | | | | White display |
| | | L | | Move toward |
| | | | | standard electrode |
| | | | | side |
| | | | | Color display |
| Non-selected | | H | H | Still (does not |
| line | | L | | move) |
| | | | | White display or |
| | | | | color display |

### <Operation in Selected Line>

In the selected line, when, for example, the high voltage is applied to the signal electrode 57, since the high voltage is applied to both of the standard electrode 59 and the signal electrode 57, so that a potential difference is not generated between the standard electrode 59 and the signal electrode 57. Whereas, since the low voltage is applied to the scanning electrode 58, a potential difference is generated between the signal electrode 57 and the scanning electrode 58. Thus, the conductive liquid 17 is moved to the scanning electrode 58 side generating the potential difference from the signal electrode 57 inside the lower space S2. As a result, the conductive liquid 17 becomes in the state shown in FIG. 9 so as to move the oil 18 toward the upper space S1 side. Thereby, the display color on the display surface side becomes in a state of the white display resulted from the light-scattering member 52.

Whereas, in the selected line, when the low voltage is applied to the signal electrode 57, since a potential difference is generated between the standard electrode 59 and the signal electrode 57, no potential difference is generated between the signal electrode 57 and the scanning electrode 58. Thus, the conductive liquid 17 is moved toward the side of the standard electrode 59 generating the potential difference from the signal electrode 57 inside the lower space S2. As a result, the conductive liquid 17 is moved to be in the state shown in FIG. 10, whereby the water 60 is moved to the inside of the upper space S1. Thereby, the display color on the display surface side becomes in the state of the color display resulted from the water 60.

### <Operation in Non-Selected Line>

In the non-selected line, when, for example, the high voltage is applied to the signal electrode 57, since the high voltage is applied to all of the standard electrode 59, the signal electrode 57 and the scanning electrode 58, no potential difference is generated between these electrodes. Thus, the conductive liquid 17 is maintained in a still state at a present position, that is, without being moved from the scanning electrode 58 side or the standard electrode 59 side. As a result, the display color is maintained without being changed from the present state of the white display or the color display.

Similarly, in the non-selected line, even when the low voltage is applied to the signal electrode 57, the conductive liquid 17 is maintained in the still state at the present position, so that the present display color is maintained. That is, since the high voltage is applied to both of the standard electrode 59 and the scanning electrode 58, a potential difference between the standard electrode 59 and the signal electrode 57 and a potential difference between the scanning electrode 58 and the signal electrode 57 are always the same.

Moreover, combinations of the voltages applied to the standard electrode 59, the scanning electrode 58 and the signal electrode 57 are not limited to those shown in Table 3, and may also be those shown in Table 4.

TABLE 4

| | | | | Behavior of |
|---|---|---|---|---|
| | | | | conductive liquid |
| | | | | and display color |
| | Standard | Signal | Scanning | on display surface |
| | electrode | electrode | electrode | side |
| Selected line | L | L | H | Move toward |
| | | | | scanning electrode |
| | | | | side |
| | | | | White display |
| | | H | | Move toward |
| | | | | standard electrode |
| | | | | side |
| | | | | Color display |
| Non-selected | | L | L | Still (does not |
| line | | H | | move) |
| | | | | White display or |
| | | | | color display |

That is, to each of the standard electrodes 59, the standard driver 56 applies the low voltage as the standard voltage Vs constantly. To the scanning electrodes 58, the scanning driver 55 applies the high voltage as the selected voltage one by one sequentially from the left side of FIG. 8 such that it becomes the selected line so as to perform the scanning operation. Moreover, the scanning driver 55 applies the low voltage as the non-selected voltage to all of the remaining scanning electrodes 58 to which the high voltage is not applied, such that each of the remaining scanning electrodes 58 becomes the non-selected line. To each of the signal electrodes 57, the signal driver 54 applies the high voltage or the low voltage as the signal voltage Vg according to the image input signal from the outside.

### <Operation in Selected Line>

In the selected line, when, for example, the low voltage is applied to the signal electrode 57, the low voltage is applied to both of the standard electrode 59 and the signal electrode 57, so that a potential difference is not generated between the standard electrode 59 and the signal electrode 57. Whereas, since the high voltage is applied to the scanning electrode 58, a potential difference is generated between the signal electrode 57 and the scanning electrode 58. Thus, the conductive liquid 17 is moved to the scanning electrode 58 side that generating the potential difference from the signal electrode 57 inside the lower space S2. As a result, the conductive liquid 17 becomes in the state shown in FIG. 9 so as to move the oil 18 toward the upper space S1 side. Thereby, the display color on the display surface side becomes in the state of the white display resulted from the light-scattering member 52.

Whereas, in the selected line, when the high voltage is applied to the signal electrode 57, since a potential difference is generated between the standard electrode 59 and the signal electrode 57, no potential difference is generated between the signal electrode 57 and the scanning electrode 58. Thus, the conductive liquid 17 is moved toward the side of the standard electrode 59 generating the potential difference from the signal electrode 57 inside the lower space S2. As a result, the conductive liquid 17 is moved to be in the state shown in FIG. 10, whereby the water 60 is moved to the inside of the upper space S1. Thereby, the display color on the display surface side becomes in the state of the color display resulted from the water 60.

### <Operation in Non-Selected Line>

In the non-selected line, when, for example, the low voltage is applied to the signal electrode 57, since the low voltage is applied to all of the standard electrode 59, the signal electrode 57 and the scanning electrode 58, and no potential difference is generated between these electrodes. Thus, the conductive liquid 17 is maintained in a still state at a present position, that is, without being moved from the upper space S1 side or the lower space S2 side. As a result, the display color is maintained without being changed from the present state of the white display or the color display.

Similarly, in the non-selected line, even when the high voltage is applied to the signal electrode 57, the conductive liquid 17 is maintained in the still state at the present position, so that the present display color is maintained. That is, since the low voltage is applied to both of the standard electrode 59 and the scanning electrode 58, a potential difference between the standard electrode 59 and the signal electrode 57 and a potential difference between the scanning electrode 58 and the signal electrode 57 are always the same.

Also in this case, similarly to Embodiment 1, the gradation display can be performed by applying, to the signal electrode 57, the signal voltage Vg in a voltage level between the high voltage and the low voltage, for example.

Next, by referring to FIG. 16, an operation of applying the voltages corresponding to the standard electrode 59, the scanning electrode 58 and the signal electrode 57 will be described. Incidentally, in the below description, the case of providing the respective three standard electrodes 59, scanning electrodes 58 and signal electrodes 57 will be illustrated for simplifying the explanation.

As shown in FIGS. 16A to 16C, respectively, high voltages are applied constantly to the three standard electrodes 59.

Moreover, as shown in FIGS. 16D to 16F, respectively, the low voltage as the selected voltage is applied sequentially to the three scanning electrodes 58 only for a certain time tO in one frame period. Moreover, in time periods except for the certain time tO, the high voltage as the non-selected voltage is applied. Incidentally, the certain time tO is obtained by dividing a time period of the one frame period by the number of the scanning electrodes 58 provided (the number of the scanning lines).

Moreover, to the three signal electrodes 57, the high voltage or the low voltage according to the image input signal from the outside are applied as the signal voltages Vg, as shown in FIGS. 16G to 16I, respectively. However, in the display device, only when the selected voltage is applied to each of the scanning electrodes 58, the signal voltage Vg applied to the signal electrode 57 becomes an effective applied voltage. That is, in the pixel regions in the cross portions of the three signal electrodes 57 and the three scanning electrodes 58, display colors in a first and second frame periods are the colors shown in Tables 5 and 6, respectively. Incidentally, Tables 5 and 6 show the display colors in the pixel regions, in the case where the first, second and third scanning electrodes 58 are provided in this order from the left side to the right side of FIG. 8, the first, second and third signal electrodes 57 are provided in this order from the upper side to the lower side of FIG. 8, and scanning operations are performed with respect to the first, second and third scanning electrodes 58 sequentially in this order. Further, before the first frame period, the display color of each of the pixel regions is provided by the color display resulted from the water 60.

TABLE 5

| | First scanning | Second scanning | Third scanning |
|---|---|---|---|
| | electrode | electrode | electrode |
| First signal | White display | Color display | White display |
| electrode | | | |
| Second signal | Color display | White display | Color display |
| electrode | | | |
| Third signal | White display | White display | Color display |
| electrode | | | |

TABLE 6

| | First scanning | Second scanning | Third scanning |
|---|---|---|---|
| | electrode | electrode | electrode |
| First signal | Color display | White display | White display |
| electrode | | | |
| Second signal | White display | Color display | White display |
| electrode | | | |
| Third signal | Color display | White display | Color display |
| electrode | | | |

According to the above-described structure, the present embodiment can achieve effects similar to those of Embodiment 1 described above. Moreover, in the present embodiment, since the scanning electrode 58 and the standard electrode 59 can be formed on the lower sheet 53 at the same time, the cost for manufacturing the display device can be reduced easily. Further, the conductive liquid 17 slides only inside the lower space S2, whereby the display color is changed. That is, in the present embodiment, since the conductive liquid 17 is moved two-dimensionally so as to change the display color without being deformed, the display color on the display surface side can be changed in a stable state. Further, a driving voltage of the conductive liquid 17 can be decreased.

### Embodiment 6

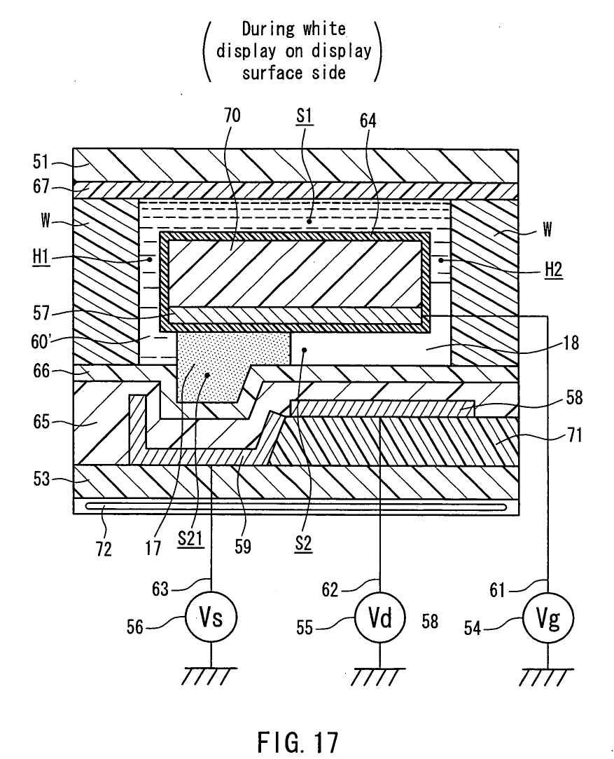

FIG. 17 is a cross-sectional view showing a structure of a main part of the display device according to Embodiment 6 of the present invention. In the figure, a main distinctive point of the present embodiment from above-described Embodiment 5 lies in structuring the intermediate layer and the lower sheet side by using a transparent sheet and providing a backlight on the back surface side of the lower sheet. Incidentally, elements provided in common with Embodiment 5 described above are given the same reference numerals, and the redundant description thereof will be omitted here.

That is, as shown in FIG. 17, in the present embodiment, the intermediate layer is constituted of the transparent sheet 70, the transparent signal electrode 57 and the transparent water-repellent film 64. Moreover, the lower sheet 53 is made of a transparent sheet material, and the scanning electrode 58, the dielectric layer 65 and the water-repellent film 66 on this lower sheet 53 are also made of transparent materials.

Moreover, as illustrated by FIG. 17, the standard electrode 59 is formed to have a substantial U-shape, and a liquid storage space S21 according to the U-shaped standard electrode 59 is formed in the lower space S2. On an upper side of this liquid storage space S21, for example, on the upper sheet 51, a light-shielding film (not illustrated) is provided, thereby preventing the color resulted from the conductive liquid 17 from being observed visually by the user, even when the conductive liquid 17 moves inside the liquid storage space S21.

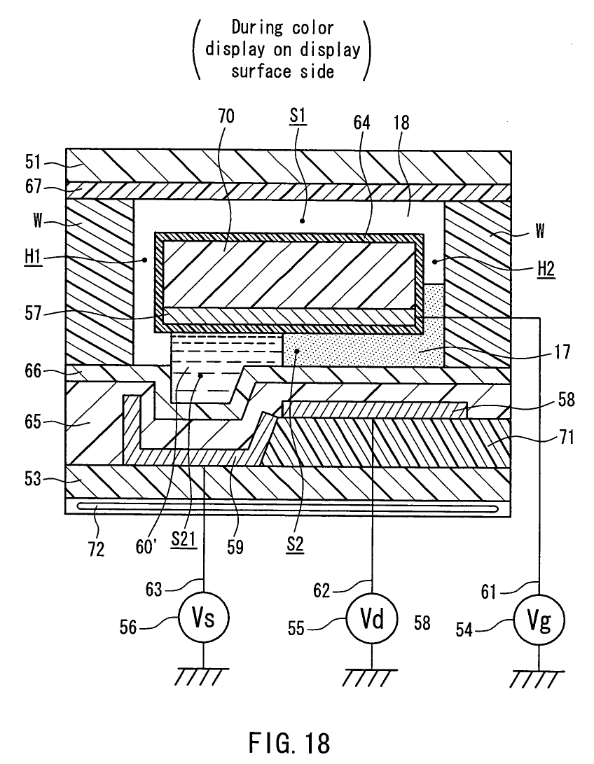

Moreover, between the lower sheet 53 and the scanning electrode 58, a transparent sheet 71 included in the lower layer is provided. Moreover, inside the liquid storage space, uncolored water 60′ is sealed, and a backlight 72 that emits white illumination light is provided on a lower side (back surface side) of the lower sheet 53. And, only an upper side of the scanning electrode 58 functions as the effective display region of each pixel. That is, as shown in FIG. 17, when the conductive liquid 17 is moved inside the liquid storage space S21, the white display is achieved by the white light from the backlight 72.

Whereas, as shown in FIG. 18, when the conductive liquid 17 slides toward the scanning electrode 58 side, the color display resulted from the conductive liquid 17 is achieved.

According to the above-described structure, the present embodiment can achieve effects similar to those of Embodiment 5 described above. Moreover, in the present embodiment, since the backlight 72 is provided so as to structure the transmission-type display device, the white display can be achieved by the illumination light from the backlight 72, and appropriate display operation can be performed even in the case where external light is not sufficient and in the night time. Thereby, the display quality of the white display can be improved easily. Moreover, when performing the color display resulted from the conductive liquid 17, by the irradiation of the illumination light from the backlight 72, the display quality of the color display can be improved easily.

Incidentally, alternatively to the above description, by changing a color of the light emitted by this backlight 72, the display color on the display surface side can be changed according to the color of the emitted light. Moreover, by using the backlight 72, brightness of the display device can be changed easily, and the display device that has a wide dimming range and can control gradation with high precision can be structured easily.

### Embodiment 7

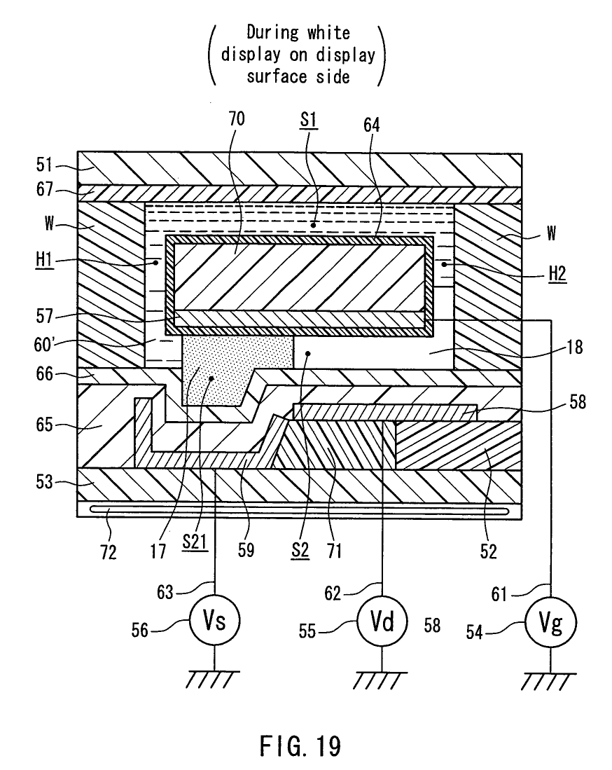

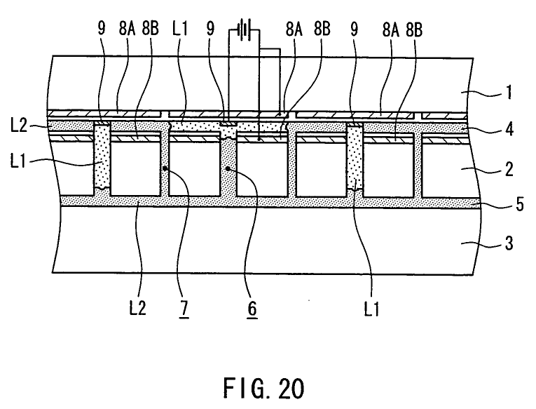

FIG. 19 is a cross-sectional view showing a structure of a main part of the display device according to Embodiment 7 of the present invention. In the figure, a main distinctive point of the present embodiment from above-described Embodiment 6 lies in the provision of the light-scattering member and the transparent sheet on the lower layer in parallel. Incidentally, elements provided in common with Embodiment 6 described above are given the same reference numerals, and the redundant description thereof will be omitted here.

That is, as shown in FIG. 19, in the present embodiment, the transparent sheet 71 and the light-scattering member 52 are provided between the lower sheet 53 and the scanning electrode 58, in parallel in the transverse direction of the figure.

According to the above-described structure, the present embodiment can achieve effects similar to those of Embodiment 6 described above. Moreover, in the present embodiment, since the transparent sheet 71, the light-scattering member 52 and the backlight 72 are provided so as to structure the semi-transmission-type display device, the white display can be achieved by reflection light of the external light by the light-scattering member 52 and the illumination light from the backlight 72, thereby performing the appropriate display operation. Thereby, the display quality of the white display can be improved easily. Moreover, since the external light can be used in combination, power consumption of the backlight 72 can be saved.

Incidentally, each of Embodiments 5 to 7 has been directed to the case where the scanning electrode 58 and the standard electrode 59 are provided on the lower sheet 53 side, and the signal electrode 57 is provided on the intermediate layer side so as to face the scanning electrode 58 and the standard electrode 59 interposing the lower space S2. However, it is also possible to provide the scanning electrode 58 and the standard electrode 59 on the intermediate layer side or the upper sheet 51 side, and provide the signal electrode 57 on the upper sheet 51 side or the lower sheet 53 side. However, it is preferable to provide the standard electrode 59 and the scanning electrode 58 on one side of either the lower sheet 53 or the intermediate layer, and to provide the signal electrode 57 on the other side of either the lower sheet 53 or the intermediate layer. That is, it is preferable to provide the signal electrode 57, the scanning electrode 58 and the standard electrode 59 on the lower space S2 side, like each of the above-described embodiments, because an opening rate (effective display region) on the display surface side can be increased easily. Moreover, it is preferable to dispose the signal electrode 57, the scanning electrode 58 and the standard electrode 59 in parallel with one another, because the driving voltage of the conductive liquid 17 can be decreased easily.

Moreover, alternatively to the description in above-described Embodiments 5 to 7, four or more kinds of fluids that are not mixed with one another can also be used. In the case of structuring as described above, three or more display colors that are different from one another can be displayed in one pixel.

Moreover, alternatively to the description in above-described Embodiments 6 and 7, it is possible to structure the transmission-type or semi-transmission-type display device similarly to those of Embodiments 6 and 7, by forming the light-shielding film on the display surface side of either one of the through holes H1, H2 in the display device of Embodiment 3 shown in FIG. 6, for example.

It should be noted that the above-described embodiments are all illustrative and not limiting. The technical scope of the present invention is defined by the claims, and all changes within the range equivalent to the configurations recited therein also are included in the technical scope of the present invention.

For example, although the above description has been directed to the case of applying the present invention to an image display including a display portion that can display a color image, the present invention can be used in any electric apparatuses provided with a display portion for displaying information containing a character and an image without any particular limitation. The present invention can be used in a preferred manner in various electric apparatuses including a display portion, for example, personal digital assistants (PDAs) such as electronic personal organizers, displays attached to personal computers and TV sets, and electronic papers.

Although the above description has been directed to the case of constituting a display device of an electrowetting system in which the liquid was moved according to the application of an electric field to this liquid, the display device of the present invention is not limited to this as long as it is a display device of an electric field induction type in which an external electric field is utilized to operate a liquid inside the display space, thereby making it possible to change a display color on the display surface side. The present invention is applicable to electric-field-induction-type display devices of other systems such as an electroosmosis system, an electrophoresis system, a dielectrophoresis system and the like.

However, in the case of structuring the display device of the electrowetting system as the above-described embodiments, the conductive liquid can be moved at a high speed by a low driving voltage, whereby a switching speed of the display color on the display surface side can be increased and the power consumption thereof can be saved easily. Thus, the case of structuring the display device of the electrowetting system is preferable because moving images can be displayed easily, and the display device with an excellent display function can be structured easily. Moreover, the display device of the electrowetting system changes the display color according to the movement of the conductive liquid, and thus has no visibility angle dependence, unlike a liquid crystal display apparatus and the like, which is also preferable.

Also, although the above description has been directed to the case of constituting the display surface including pixel regions for individual colors of R, G and B, the present invention is not limited to this as long as a plurality of pixel regions are provided respectively for a plurality of primary colors allowing a full color display on the display surface side. More specifically, liquid storage spaces in which conductive liquids colored respectively in cyan (C), magenta (M) and yellow (Y) are sealed are provided instead of the pixel regions for R, G and B described above, thus constituting the pixel regions for individual colors of C, M and Y However, in the case of constituting the pixel regions for C, M and Y, it is more preferable to provide a pixel region for black display having a conductive liquid colored in black because the display quality of black display may deteriorate compared with the case of R, G and B. Furthermore, it also is possible to use conductive liquids colored in predetermined colors corresponding to combinations of a plurality of primary colors that can display a color image on the display surface other than R, G, B and C, M, Y, for example, R, G, B, Y, C (five colors), R, G, B, C (four colors), R, G, B, Y (four colors), G, M (two colors), etc.

Moreover, the above description has been directed to the case of using the ionic liquid as the conductive liquid, but the conductive liquid of the present invention is not limited to this, and for example, alcohol, acetone, formamide, ethyleneglycol, water or a mixture thereof may also be used as the conductive liquid.

Moreover, the above description has been directed to the case of using the nonpolar oil, but the present invention is not limited to this, and an insulating fluid that is not mixed with the conductive liquid may be used, for example, the air may be used instead of the oil. In addition, as the oil, silicone oil, fatty hydrocarbon and the like can be used. However, it is preferable to use the nonpolar oil that is not compatible with the ionic liquid as the above-described embodiment, because a droplet of the ionic liquid can be moved in the nonpolar oil more easily than the case of using the air and the ionic liquid, and the ionic liquid (conductive liquid) can be moved at a high speed so as to switch the display color at a high speed.

Moreover, the above description has been directed to the case of providing the standard electrode and the scanning electrode on the surfaces of the insulating sheets such as the upper sheet and the lower sheet, but the present invention is not limited to this, and can also use the standard electrode and the scanning electrode that are buried inside the above-described sheets made of insulating materials. In the case of structuring as described above, the sheets can function also as the dielectric layer, and the provision of the dielectric layer can also be omitted.

### INDUSTRIAL APPLICABILITY

The display device of the present invention and the electric apparatus using the same can prevent the generation of a crosstalk without providing the active element, and thus has an excellent display function, so that the display device and the electric apparatus with simple structures can be provided at low costs.

1. A display device provided with:
a transparent upper layer that is provided on a display surface side;
an intermediate layer that is provided on a back surface side of the upper layer such that a predetermined upper space is formed between the upper layer and the intermediate layer;
a lower layer that is provided on a back surface side of the intermediate layer such that a predetermined lower space is formed between the lower layer and the intermediate layer;
a communication space that is provided in the intermediate layer such that the upper space and the lower space are connected; and
a conductive liquid sealed movably inside a liquid storage space that is constituted of the upper space, the lower space and the communication space,
wherein a display color on the display surface side can be changed by moving the conductive liquid,
the display device comprising:
a standard electrode that is provided on the upper layer or the lower layer;
a plurality of signal electrodes that are provided on the intermediate layer;
a plurality of scanning electrodes that are provided on the upper layer or the lower layer so as to cross the plurality of the signal electrodes;
a standard voltage applying portion that is connected with the standard electrode and applies a predetermined standard voltage to the standard electrode;
a signal voltage applying portion that is connected with the plurality of the signal electrodes and applies, to each of the plurality of the signal electrodes, a signal voltage according to information to be displayed on the display surface; and
a scanning voltage applying portion that is connected with the plurality of the scanning electrodes, and applies, to each of the plurality of the scanning electrodes, one of a non-selected voltage that inhibits movement of the conductive liquid inside the liquid storage space and a selected voltage that allows the conductive liquid to move inside the liquid storage space according to the signal voltage, when the standard voltage applying portion applies the standard voltage to the standard electrode.

2. The display device according to claim 1, wherein
a plurality of pixel regions are set on the display surface,
each of the plurality of the pixel regions is provided in each cross portion of the signal electrode and the scanning electrode, and
the liquid storage space is partitioned by a partition wall in each of the plurality of the pixel regions.

3. The display device according to claim 2, wherein the plurality of the pixel regions are respectively provided on the display surface side according to a plurality of primary colors that enable full-color display.

4. The display device according to claim 1, wherein
the standard voltage applying portion switches a polarity of the standard voltage at every predetermined period of time, and
the scanning voltage applying portion switches respective polarities of the non-selected voltage and the selected voltage so as to correspond to the switching of the polarity of the standard voltage.

5. The display device according to claim 1, wherein the signal voltage applying portion changes the signal voltage based on an image input signal from an outside.

6. The display device according to claim 1, wherein
the standard electrode is provided on one side of either the upper layer or the lower layer,
the scanning electrode is provided on other side of the upper layer or the lower layer where the standard electrode is not provided, and
the display color on the display surface side is changed by moving the conductive liquid toward the upper space side or the lower space side.

7. The display device according to claim 1, wherein a planar conductive film is used as the standard electrode.

8. The display device according to claim 1, wherein an insulating fluid that is not mixed with the conductive liquid is sealed movably inside the liquid storage space.

9. The display device according to claim 1, wherein the standard electrode and the scanning electrode are provided on the upper layer or the lower layer, and
the display color on the display surface side is changed by moving the conductive liquid toward the standard electrode side or the scanning electrode side.

10. The display device according to claim 1, wherein
the standard electrode and the scanning electrode are provided on one side of either the lower layer or the intermediate layer, and
the signal electrode is provided on other side of the lower layer or the intermediate layer so as to face the standard electrode and the scanning electrode interposing the lower space.

11. The display device according to claim 9,
a first insulating fluid that is not mixed with the conductive liquid and a second insulating fluid that is not mixed with the conductive liquid and the first insulating fluid are sealed movably inside the liquid storage space, and
the display color on the display surface side is changed by moving the first or second insulating fluid toward the upper space side.

12. The display device according to claim 1, wherein a first communication space that connects one end portion side of the upper space and one end portion side of the lower space, and a second communication space that connects other end portion side of the upper space and other end portion side of the lower space are provided in the liquid storage space.

13. The display device according to claim 1, wherein a dielectric layer is layered on surfaces of the standard electrode and the scanning electrode.

14. The display device according to claim 1, wherein the display surface side of the intermediate layer has a light scattering function.

15. The display device according to claim 1, wherein
a transparent sheet is used for the intermediate layer and the lower layer, and
a backlight is provided on a back surface side of the lower layer.

16. The display device according to claim 1, wherein
a transparent sheet is used for the intermediate layer,
the lower layer includes a light scattering member and a transparent sheet that are provided in parallel, and
a backlight is provided on a back surface side of the lower layer.

17. An electric apparatus comprising a display portion that displays information including a letter and an image, wherein
the display device according to claim 1 used for the display portion.
